(19) United States
(12) Patent Application Publication
(10) Pub. No.: US 2007/0241729 A1
(43) Pub. Date: Oct. 18, 2007

(54) POWER SUPPLY APPARATUS AND TEST APPARATUS

(75) Inventor: Yoshihiro Hashimoto, Tokyo (JP)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ADVANTEST CORPORATION, TOKYO (JP)

(21) Appl. No.: 11/693,693

(22) Filed: Mar. 29, 2007

Related U.S. Application Data
(63) Continuation of application No. PCT/JP05/17413, filed on Sep. 21, 2005.

(30) Foreign Application Priority Data
Sep. 30, 2004 (JP) JP 2004-288930

(51) Int. Cl. G05F 1/00

(52) U.S. Cl. 323/274

(57) ABSTRACT

Provided is a power supply apparatus including: a connection resistance that supplies a power supply current of an electronic device to the electronic device; a low pass filter that allows passage of an output voltage of a power current output section; a parallel load section that consumes a partial power current being a part of the output power current when receiving a power current decrease signal and stops receiving the partial power current when receiving a power current increase signal; an offset adder section that outputs a voltage obtained by adding an offset voltage to the output voltage of the low pass filter; and a difference detection section that supplies the power current increase signal to the parallel load section while a potential of a device side end of the connection resistance is smaller than a reference voltage obtained by subtracting a reference potential difference from the output voltage of the offset adder section, and supplies the power current decrease signal to the parallel load section when the potential of the device side end becomes larger than the reference voltage, where the offset adder section adjusts the offset voltage when the first reference potential difference is changed according to change in the output voltage of the low pass filter.

### CROSS REFERENCE TO RELATED APPLICATION

This is a continuation application of PCT/JP2005/017413 filed on Sep. 21, 2005 which claims priority from a Japanese Patent Application(s) No. 2004-288930 filed on Sep. 30, 2004, the contents of which are incorporated herein by reference.

### BACKGROUND

1. Technical Field

The present invention relates to a power supply apparatus and a test apparatus. In particular, the present invention relates to a power supply apparatus and a test apparatus for stably supplying a power supply current to an electronic device.

2. Related Art

Electronic devices such as CMOS semiconductors are subjected to great power supply change when the internal circuits therein are under operation. Conventionally, voltage generating circuits are known by which generated voltage fluctuation given to a load in an operational characteristic test for an electronic device is small as disclosed, for example, in Japanese Patent Application Publication No. H7-333249, pages 2-4, FIGS. 1-5.

Recent improvement in nanotechniques has advanced speed acceleration and voltage reduction of electronic devices, which has reduced an allowable range of a power supply voltage fluctuation for electronic devices. Accordingly, test apparatuses for testing such electronic devices have come to require power supply apparatuses of further high accuracy.

An object of the present invention is to provide a power supply apparatus and a test apparatus that can solve the above-stated problems. This object is achieved by a combination of the features recited in the independent claims of the present invention. Moreover, the dependent claims define further advantageous concrete examples of the present invention.

### SUMMARY

So as to solve the foregoing problems, according to the first aspect of the present invention, there is provided a power supply apparatus for supplying a power supply current to an electronic device, the power supply apparatus including: a power current output section that outputs an output power current that at least partially includes the power supply current; a connection resistance that supplies, to the electronic device, the power supply current received from the power current output section, by electrically connecting the power current output section and the electronic device; a tow pass filter that has a cut-off frequency lower than a variety of frequencies of the power supply current received by the electronic device, and allows passage of an output voltage of the power current output section, by reducing a frequency component higher than the cut-off frequency; a parallel load section connected to an output end of the power current output section so as to be in parallel with the connection resistance, wherein the parallel load section a) consumes a partial power current being a part of the output power current from the power current output section when receiving a power current decrease signal instructing to decrease the power supply current, and b) stops receiving the partial power current from the power current output section when receiving a power current increase signal instructing to increase the power supply current; an offset adder section that outputs a voltage obtained by adding an offset voltage to the output voltage of the low pass filter; and a difference detection section that a) supplies the power current increase signal to the parallel load section while a potential of a device side end of the connection resistance positioned near the electronic device is smaller than a first reference voltage obtained by subtracting a first reference potential difference from the output voltage of the offset adder section, and b) supplies the power current decrease signal to the parallel load section when the potential of the device side end becomes larger than the first reference voltage, where the offset adder section, according to change in the output voltage of the low pass filter, a) increases the offset voltage when the first reference potential difference is increased, and b) decreases the offset voltage when the first reference potential difference is decreased.

An arrangement is also possible in which the difference detection section a) supplies the power current decrease signal to the parallel load section while the potential of the device side end is larger than a second reference voltage obtained by subtracting a second reference potential difference from the output voltage of the offset adder section, and b) supplies the power current increase signal to the parallel load section when the potential of the device side end becomes smaller than the second reference voltage, and the offset adder section, according to change in the output voltage of the low pass filter, a) increases the offset voltage when the second reference potential difference is increased, and b) decreases the offset voltage when the second reference potential difference is decreased.

An arrangement is also possible in which the difference detection section includes: a reference voltage output section that outputs either the first reference voltage or the second reference voltage that is smaller than the first reference voltage, by dividing the output voltage of the offset adder section; a first comparator that a) outputs the power current decrease signal to an output signal line when the potential of the device side end is larger than the reference voltage, and b) outputs the power current increase signal to the output signal line when the potential of the device side end is smaller than the reference voltage; and a reference voltage setting section that, according to the output from the first comparator, causes the reference voltage output section to a) output the second reference voltage when the potential of the device side end becomes larger than the first reference voltage, and b) output the first reference voltage when the potential of the device side end becomes smaller than the second reference voltage, and the parallel load section, based on the power current increase signal and the power current decrease signal supplied from the output signal line of the first comparator, a) consumes the partial power current received from the power current output section by running the partial power current to a path that is parallel to the connection resistance, during a period after the potential of the device side end has become larger than the first reference voltage till the potential of the device side end becomes smaller than the second reference voltage, and b) stops running the partial power current to the parallel path, during a period after the potential of the device side end has become smaller than the second reference voltage till the potential of the device side end becomes larger than the first reference voltage.

An arrangement is also possible in which the offset adder section includes: a first resistance connected to a third reference voltage higher than the output voltage of the low pass filter; a second resistance connected between an output of the offset adder and an end of the first resistance to which the third reference voltage is not connected; and a second comparator receiving input of the output voltage of the low pass filter and a voltage at a junction between the first resistance and the second resistance, the second comparator a) lowering the output voltage of the offset adder section when the voltage at the junction is larger than the output voltage of the low pass filter, and b) raising the output voltage of the offset adder section when the voltage at the junction is smaller than the output voltage of the low pass filter.

The power supply apparatus may further include: a delay section that delays more a timing of starting supplying the power current decrease signal to the parallel load section when a period since the difference detection section starts supplying the power current increase signal till the difference detection section starts supplying the power current decrease signal is longer.

According to the second aspect of the present invention, there is provided a power supply apparatus for supplying a power supply current to an electronic device, the power supply apparatus including: an output power current section that outputs an output power current that at least partially includes the power supply current; a connection resistance that supplies, to the electronic device, the power supply current received from the power current output section, by electrically connecting the power current output section and the electronic device; a low pass Filter that has a cut-off frequency lower than a variety of frequencies of the power supply current received by the electronic device, and allows passage of an output voltage of the power current output section, by reducing a frequency component higher than the cut-off frequency; a parallel load section connected to an output end of the power current output section so as to be in parallel with the connection resistance, wherein the parallel load section a) consumes a partial power current being a part of the output power current from the power current output section when receiving a power current decrease signal instructing to decrease the power supply current, and b) stops receiving the partial power current from the power current output section when receiving a power current increase signal instructing to increase the power supply current; a difference detection section that a) supplies the power current increase signal to the parallel load section when a potential of a device side end of the connection resistance positioned near the electronic device is smaller than a first reference voltage obtained by subtracting a predetermined value from the output voltage of the low pass filter, and b) supplies the power current decrease signal to the parallel load section when the potential of the device side end becomes larger than the first reference voltage; and a delay section that delays more a timing of starting supplying the power current decrease signal to the parallel load section when a period since the difference detection section starts supplying the power current increase signal till the difference detection section starts supplying the power current decrease signal is longer.

An arrangement is also possible in which, when the period since the difference detection section starts supplying the power current increase signal till the difference detection section starts supplying the power current decrease signal is longer, the delay section sets a time delay from when the difference detection section supplies the power current decrease signal and to when the power current decrease signal is supplied to the parallel load section longer than a time delay from when the difference detection section supplies the power current increase signal to when the power current increase signal is supplied to the parallel load section.

The delay section may include: a base power current supply section that a) supplies a first base power current when the power current decrease signal is being supplied from the difference detection section, and b) supplies a second base power current that is larger than the first base power current when the power current increase signal is being supplied from the difference detection section; a transistor that receives, at a base, input of the base power current supplied from the power current supply section, and saturates when receiving input of the second base power current; and a power current control signal output section that a) supplies the power current increase signal to the parallel load section, during an ON period of the transistor that is composed of a period in which the transistor is receiving input of the second base power current and a period in which the transistor is saturated, and b) supplies the power current decrease signal to the parallel load section in an OFF period in which the transistor is receiving input of the first power current and the transistor is not saturated.

The base power current supply section may include: a first gate that a) outputs a signal of H level when supplied with the power current increase signal from the difference detection section, and b) outputs a signal of L level when supplied with the power current decrease signal from the difference detection section; a third resistance provided between an output of the first gate and the base of the transistor; and a diode provided in parallel with the third resistance, wherein the output of the first gate and the cathode are respectively connected to the base of the transistor and the anode.

According to the third aspect of the present invention, there is provided a test apparatus for testing an electronic device, the test apparatus including: a power current output section that outputs an output power current that at least partially includes a power supply current to be received by the electronic device; a connection resistance that supplies, to the electronic device, the power supply current received from the power current Output section, by electrically connecting the power current output section and the electronic device; a low pass filter that has a cut-off frequency lower than a variety of frequencies of the power supply current received by the electronic device, and allows passage of an output voltage of the power current output section, by reducing a frequency component higher than the cut-off frequency; a parallel load section connected to an output end of the power current output section so as to be in parallel with the connection resistance, wherein the parallel load section a) consumes a partial power current being a part of the output power current from the power current output section when receiving a power current decrease signal instructing to decrease the power supply current, and b) stops receiving the partial power current from the power current output section when receiving a power current increase signal instructing to increase the power supply current; an offset adder section that outputs a voltage obtained by adding an offset voltage to the output voltage of the low pass filter; and a difference detection section that a) supplies the power current increase signal to the parallel load section while a potential of a device side end of the connection resistance positioned near the electronic device is smaller than a first reference voltage obtained by subtracting a first reference potential difference from the output voltage of the offset adder section, and b) supplies the power current decrease signal to the parallel load section when the potential of the device side end becomes larger than the first reference voltage; a pattern generating section that generates a test pattern to be inputted to the electronic device; a signal input section that supplies the test pattern to the electronic device that receives the power supply current; and a judgment section that judges whether the electronic device is defective or non-defective based on a signal that the electronic device outputs according to the test pattern, where the offset adder section a) increases the offset voltage when the first reference potential difference is increased, and b) decreases the offset voltage when the first reference potential difference is decreased, according to change in the output voltage of the low pass filter.

According to the fourth aspect of the present invention, there is provided a test apparatus for testing an electronic device, the test apparatus including a power current output section that outputs an output power current that at least partially includes the power supply current; a connection resistance that supplies, to the electronic device, the power supply current received from the power current output section, by electrically connecting the power current Output section and the electronic device; a low pass filter that has a cut-off-frequency lower than a variety of frequencies of the power supply current received by the electronic device, and allows passage of an output voltage of the power current output section, by reducing a frequency component higher than the cut-off frequency; a parallel load section connected to an output end of the power current output section so as to be in parallel with the connection resistance, wherein the parallel load section a) consumes a partial power current being a part of the output power current from the power current output section when receiving a power current decrease signal instructing to decrease the power supply current and b) stops receiving the partial power current from the power current output section when receiving a power current increase signal instructing to increase the power supply current; a difference detection section that a) supplies the power current increase signal to the parallel load section when a potential of a device side end of the connection resistance positioned near the electronic device is smaller than a first reference voltage obtained by subtracting a predetermined value from the output voltage of the low pass filter, and b) supplies the power current decrease signal to the parallel load section when the potential of the device side end becomes larger than the first reference voltage; a delay section that delays more a timing of starting supplying the power current decrease signal to the parallel load section when a period since the difference detection section starts supplying the power current increase signal till the difference detection section starts supplying the power current decrease signal is longer; a pattern generating section that generates a test pattern to be inputted to the electronic device; a signal input section that supplies the test pattern to the electronic device that receives the power supply current; and a judgment section that judges whether the electronic device is defective or non-defective based on a signal that the electronic device outputs according to the test pattern.

According to the fifth aspect of the present invention, there is provided a power supply apparatus that supplies a power supply current to an electronic device. The power supply apparatus includes: a power current output section that outputs an output current including the power supply current supplied to the electronic device; a load section that consumes a part of the output current; and a difference detection section that reduces the power consumption of the load section in response to detecting that the power supply current consumed by the electronic device is increased.

The power supply apparatus further includes: a connection resistance connected between the power current output section and the electronic device that supplies to the electronic device, the power supply current received from the power current output section; and an offset adder section that outputs a voltage obtained by adding all offset voltage to the output voltage of the power current output section. The difference detection section may include a reference voltage output section that outputs a reference voltage based on the output voltage of the offset adder section and reduce the power consumption of the load section when the electric potential of the end of the electronic device side of the connection resistance close to the electronic device is less than the reference voltage. The offset adder section may regulate the offset voltage so as to stabilize the potential difference between the output voltage of the power supply output section and the reference voltage when the magnitude of the output voltage of the offset adder section is changed.

The difference detection section may increase the power consumption of the load section in response to detecting that the power supply current is reduced and reduce the power consumption in response to detecting that the power supply current is increased. The power supply apparatus may further include a delay section that delays more a timing of increasing the power consumption when a period since the difference detection section reduces the power consumption till the difference detection section increases the power consumption is longer.

According to the sixth aspect of the present invention, there is provided a test apparatus that tests an electronic device. The test apparatus includes: a power supply apparatus that supplies a power supply current to the electronic device; and a test section that tests the electronic device. The power supply apparatus includes: a power current output section that outputs an output current including the power supply current supplied to the electronic device; a load section that consumes a part of the output current; and a difference detection section that reduces the power consumption of the load section in response to detecting that the power supply current consumed by the electronic device is increased.

The power supply apparatus further includes: a connection resistance connected between the power current output section and the electronic device that supplies to the electronic device, the power supply current received from the power current output section; and an offset adder section that outputs a voltage obtained by adding an offset voltage to the output voltage of the power current output section. The difference detection section may include a reference voltage output section that outputs a reference voltage based on the output voltage of the offset adder section and reduce the power consumption of the load section when the electric potential of the end of the electronic device side of the connection resistance close to the electronic device is less than the reference voltage. The offset adder section may correct the offset voltage so as to stabilize the potential difference between the output voltage of the power supply output section and the reference voltage when the magnitude of the output voltage of the offset adder section is changed.

The difference detection section may increase the power consumption of the load section in response to detecting that the power supply current is reduced and reduce the power consumption in response to detecting that the power supply current is increased. The test apparatus may further include a delay section that delays more a timing of increasing the power consumption when a period since the difference detection section reduces the power consumption till the difference detection section increases the power consumption is longer.

The above-stated summary does not necessarily describe all necessary features of the present invention. The present invention may also be a sub-combination of the features described above.

The present invention provides a power supply apparatus that supplies a stable power supply voltage to an electronic device, and a test apparatus that tests an electronic device with high accuracy using the power supply apparatus.

### BRIEF DESCRIPTION OF THE DRAWINGS

FIG. 1 shows a configuration of a test apparatus 100 according to an embodiment of the present invention.

FIG. 2 shows a configuration of a power supply section 106 according to an embodiment of the present invention.

FIG. 3 shows a configuration of a power current consumption section 306 according to an embodiment of the present invention.

FIG. 4 shows one example of an operation performed by the power current consumption section 306 according to an embodiment of the present invention.

FIG. 5 shows one example of a detailed operation performed by the power current consumption section 306 according to an embodiment of the present invention.

FIG. 6 shows a configuration of an offset adder section 450 according to an embodiment of the present invention.

FIG. 7 shows one example of a reference potential difference in a test apparatus 100 that is not equipped with the offset adder section 450.

FIG. 8 shows one example of a reference potential difference in the test apparatus 100 according to an embodiment of the present invention.

FIG. 9 shows a configuration of a delay section 452 according to an embodiment of the present invention.

FIG. 10 shows one example of an operation performed by the delay section 452 according to an embodiment of the present invention.

FIG. 11 shows a relationship between an operation performed by the test apparatus 100 and an output power current from a power current Output section 302, according to an embodiment of the present invention.

FIGS. 12A and 12B respectively show an example of a detailed operation performed by the test apparatus 100 by means of the delay section 452 according to an embodiment of the present invention.

### DESCRIPTION OF EXEMPLARY EMBODIMENTS

Hereinafter, one aspect of the present invention will be described through one or more embodiments. The embodiments do not intend to restrict the inventions in the claims, and not all the combinations of the features explained in the embodiments are always necessary for the means for solving the present invention.

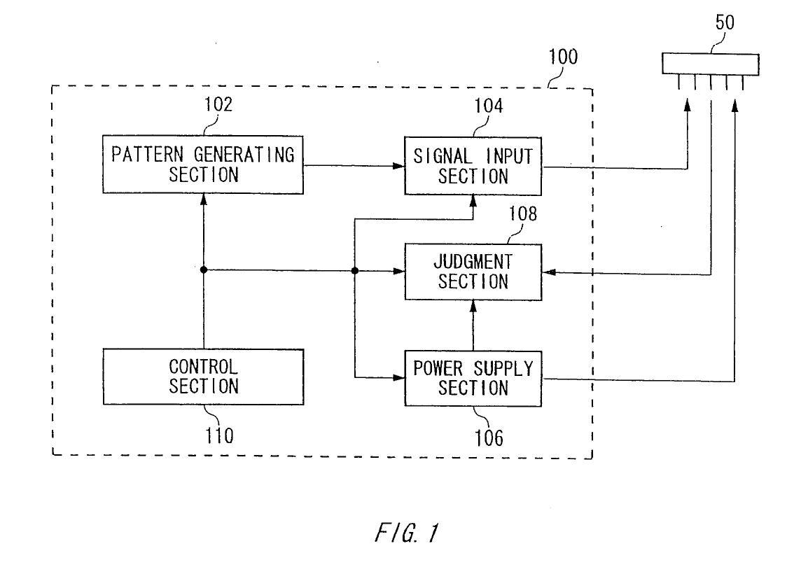

FIG. 1 shows a configuration of a test apparatus 100 according to the present embodiment, together with an electronic device 50. The electronic device 50 is a device to be subjected to a test (DUT) such as an LSI. The test apparatus 100 of the present example aims to test the electronic device 50 with high accuracy. The test apparatus 100 includes a control section 110, a power supply section 106, a pattern generating section 102, a signal input section 104, and a judgment section 108. The control section 110 controls the power supply section 106, the pattern generating section 102, the signal input section 104, and the judgment section 108.

The power supply section 106 is a power supply apparatus for supplying a power supply current to the electronic device 50. The pattern generating section 102 generates a test pattern to be inputted to the electronic device 50, and supplies the (generated test pattern to the signal input section 104. The signal input section 104 supplies the test pattern to the electronic device 50 receiving the power supply current from the power supply section 106, at a pre-set timing by delaying the test pattern by a predetermined time delay for example. The judgment section 108 judges whether the electronic device 50 is defective or non-defective based on a signal that the electronic device 50 outputs according to the test pattern.

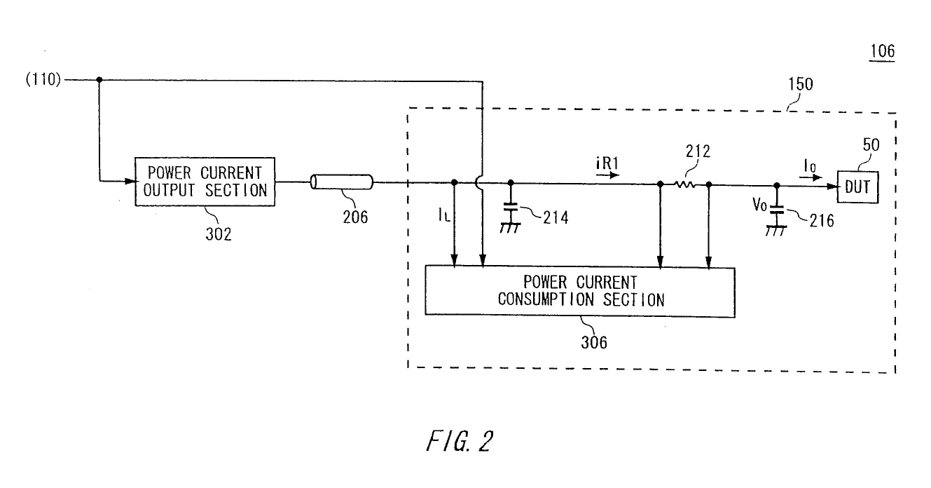

FIG. 2 shows a configuration of the power supply section 106 according to the present embodiment, together with the electronic device 50. The power supply section 106 includes a power current output section 302, a connection line 206, a plurality of capacitors (214, 216), and a resistance 212. In the present example, the electronic device 50 receives a terminal voltage Vo of the capacitor 216, as a power supply voltage.

In the present example, the power current consumption section 306, the capacitor 214, the capacitor 216, and the resistance 212 are provided on a user interface 150. The user interface 150 is one example of a print substrate on which wiring for electrically connecting the power current output section 302 and the electronic device 50. One example of the user interface 150 is a performance board for mounting thereon the electronic device 50. It should be noted here that the test apparatus 100 may test the electronic device 50 in the state of wafer, for example. In such a case, the electronic device 50 is connected to the user interface 150 via a probe card for example.

The power current Output section 302 is a device power source that supplies power to the electronic device 50. The power current output section 302 supplies a power supply current iR1 which is at least a part of an output power current, to the electronic device 50 via the connection line 206 and the resistance 212, by outputting a voltage based on an instruction of the control section 110, for example. In the present example, the power supply current iR1 constitutes at least one part of a power supply current Io to be received by the electronic device 50.

When instructed by the control section 110 to operate, the power current consumption section 306 consumes a partial power current IL being a part of the output power current of the power current output section 302, by flowing the same to a path that is parallel to the electronic device 50. In this case, the power current output section 302 and the power current consumption section 306 supply an amount of power current obtained by subtracting the partial power current IL from the output power current to the electronic device 50 as the power supply current iR1.

In addition, the power current consumption section 306 detects reduction of the terminal voltage Vo of the capacitor 216, based on the voltage generated at the resistance 212. When reduction in the terminal voltage Vo has been detected, the power current consumption section 306 stops consuming the partial power current IL. In this case, the power current output section 302 and the power current consumption section 306 increase the power supply current iR1 by supplying substantially all the output power current to the electronic device 50 as the power supply current iR1 thereby raising the terminal voltage Vo. As a consequence, the present example enables to sustain the terminal voltage Vo of the capacitor 16 stable, thereby enabling to test the electronic device 50 with high accuracy.

The connection line 206 is for example a coaxial cable, and electrically connects the power current output Section 302 and the user interface 150. The capacitor 214 is one example of a smoothing capacitor, whose one end is connected to the power current output section 302 via the connection line 206, and the other end thereof is connected to ground. The one end of the capacitor 214 is electrically connected to the resistance 212. Accordingly, the capacitor 214 is able to smooth the power supply current Io of the electronic device 50 in the upperstream than the resistance 212 in the power current direction, by smoothing the power supply current iR1 outputted from the power current output section 302.

The capacitor 216 is one example of a device side capacitor, and has a smaller capacitance than that of the capacitor 214. In addition, one end of the capacitor 216 is connected to the electronic device 50 and the other end thereof is connected to ground. Further, the one end of the capacitor 216 is electrically connected to the capacitor 214 via the resistance 212. Accordingly, the capacitor 216 smoothes the power supply current iR1 in more downstream than the resistance 212 in the power current direction. The capacitor 216 may smooth the power supply current Io that the resistance 212 supplies to the electronic device 50.

The resistance 212 is one example of a connection resistance, and is provided between respective ends of the capacitor 214 and the capacitor 216 which are not connected to ground. Accordingly, the resistance 212 electrically connects the power current output section 302 and the electronic device 50, and supplies the power supply current iR1 to the electronic device 50.

In addition, the resistance 212 supplies voltage caused at both ends thereof according to the power supply current iR1 to the power current consumption section 306. During this, the resistance 212 is used to detect reduction of the terminal voltage Vo of the capacitor 216, instead of the absolute value of the running power current. For this reason, the resistance 212 may be a pattern resistance formed on the user interface 150. The electric resistance of the resistance 212 may be approximately 5 mΩ for example. For example, the resistance 212 may be a pattern resistance of which the thickness of copper wiring is about 35 μm, the pattern width is about 10 mm, and the pattern length is about 10 cm.

Suppose a case where the capacitor 214 and the capacitor 216 are replaced by a single capacitor for example, for the purpose of smoothing the power supply current Io. If the single capacitor has a small capacity, the fluctuation of the terminal voltage of the capacitor incident to the change in the power supply current Io becomes large, resulting in unstable power supply voltage for the electronic device 50. On the contrary, if the single capacitor has a large capacity, recovery required when the terminal voltage of the capacitor has changed takes time, making it difficult to maintain an adequate power Supply voltage for the electronic device 50.

On the other hand, the present embodiment provides a capacitor 216 for smoothing the power supply current Io in the immediate vicinity of the electronic device 50 as well as the capacitor 214 for smoothing a large power supply current iR1 in performing a functional test of the electronic device 50 or the like. The stated arrangement regarding provision of the capacitors 214 and 216 enables to reduce fluctuations of the power supply voltage affected by the fluctuation of the power supply current Io in performing a functional test for example.

Here suppose that the power supply voltage of the electronic device 50 is 2V, and the allowable range of fluctuation for the power supply voltage is 5%. Then the fluctuation for the power supply voltage should be no more than approximately 50 mV, by further taking into consideration tolerance of 0.5. In this case, the capacitance of the capacitor 214 can be for example (0.4A×5μ second)/50 mV=40 μF, under assumptions that in a functional test, the functional rate is 10 n second, the peak power current is 1A, the period during which the peak power current runs is 4 n second, and the response time required for changing the output power current by means of the power current output section 302 and the power current consumption section 306 is 5μ second. Furthermore, the capacitor 216 may for example have the capacitance in the amount corresponding to no more than about 1/10 of the capacitance of the capacitor 214.

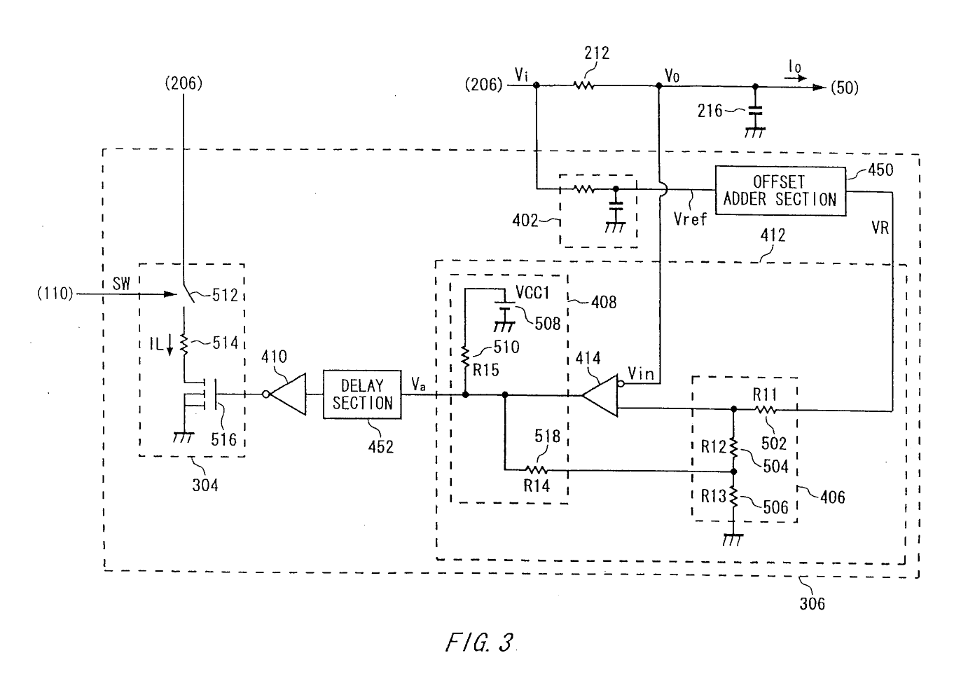

FIG. 3 shows a configuration of the power current consumption section 306 according to the present embodiment. The power current consumption section 306 includes a low pass filter 402, an offset adder section 450, a difference detection section 412, a delay section 452, a load driving section 410, and a parallel load section 304. The low pass filter 402, the offset adder section 450, the difference detection section 412, the delay section 452, the load driving section 410, and the parallel load section 304 may be provided on the user interface 150 (See FIG. 2).

The low pass filter 402 includes a resistance and a capacitor, where the resistance connects a power source side end of the resistance 212 positioned near the connection line 206, to one end of the capacitor. The other end of the capacitor of the low pass filter 402 is connected to ground. Accordingly, the low pass filter 402 receives the output voltage of the power current output section 302 (See FIG. 2), reduces the high frequency component thereof, and supplies the result to the difference detection section 412 via the offset adder section 450.

It is desirable that the low pass filter 402 has a cut-off frequency lower than the variety of frequencies of the power supply current Io received by the electronic device 50. In this case, the low pass filter 402 reduces a frequency component higher than this cut-off frequency, to allow passage of the output voltage of the power current output section 302. Additionally in the present example, the low pass filter 402 receives the voltage Vi at the power source side end of the resistance 212, as an output voltage of the power current output section 302, and supplies the voltage Vref obtained by reducing the high-frequency component of the voltage Vi, to the difference detection section 412 via the offset adder section 450.

The offset adder section 450 adjusts the output voltage Vref of the low pass filter 402 by outputting the voltage obtained by adding an offset voltage to the output voltage of the low pass filter 402. Here, when conducting a test of changing the power supply voltage of the electronic device 50, or when testing electronic devices 50 having different power supply voltage specifications from one another, the difference between the power supply voltage and the comparison voltage of the difference detection section 412 changes according to the change in the power supply voltage. In view of this, the offset adder section 450 adds an offset voltage to the output voltage of the low pass filter 402 according to the change in the power supply voltage, thereby curbing fluctuation of the difference between the power supply voltage and the comparison voltage of the difference detection section 412.

The difference detection section 412 compares the output voltage of the offset adder section 450 (i.e. the output voltage of the offset adder section 450 is obtained by adjusting the output voltage Vref of the low pass filter 402 by the offset adder section 450) and the potential Vo at a device side end of the resistance 212 positioned near the electronic device 50. Then based on the comparison result, the difference detection section 412 controls, by means of the parallel load section 304, whether to consume at least part of the output power current of the power current output section 302. More specifically, the difference detection section 412 supplies a power current increase signal to the parallel load section 304 when the terminal voltage Vo is smaller than a first reference voltage VH obtained by subtracting a predetermined value from the output voltage Vref of the low pass filter 402. On the contrary, when the terminal voltage Vo gets larger than the first reference voltage VH, the difference detection section 412 supplies a power current decrease signal to the parallel load section 304. The power current increase signal is for instructing the parallel load section 304 to increase the power supply current.

In addition, when the terminal voltage Vo is larger than a second reference voltage VL obtained by subtracting a predetermined value from the output voltage Vref of the low pass filter 402, the difference detection section 412 supplies a power current decrease signal to the parallel load section 304. On the contrary, when the terminal voltage Vo gets smaller than the second reference voltage VL, the difference detection section 412 supplies a power current increase signal to the parallel load section 304. The power current decrease signal is for instructing the parallel load section 304 to decrease the power supply current. When a hysteresis is provided, the second reference voltage VL is set as a smaller value than the first reference voltage VH. In a configuration which does not use the offset adder section 450, the output from the low pass filter 402 is connected to the difference detection section 412.

The difference detection section 412 includes a reference voltage output section 406, a comparator 414, and a reference voltage setting section 408.

The reference voltage output section 406 has a plurality of resistances 502, 504, and 506, which are connected in series and provided between the output of the offset adder section 450 and the ground potential. The reference voltage output section 406 outputs a potential of a node between the resistance 502 and the resistance 504, as a reference voltage to be supplied to the comparator 414. Accordingly, the reference voltage output section 406 outputs a reference voltage obtained by dividing the output voltage of the low pass filter 402 based on the electric resistance ratio of the plurality of resistances 502, 504, and 506.

In addition, the reference voltage output section 406 receives the output from the reference voltage setting section 408 at the node between the resistance 504 and the resistance 506. Accordingly, the reference voltage output section 406 outputs either the first reference voltage or the second reference voltage, in accordance with the output from the reference voltage setting section 408.

The comparator 414 receives the reference voltage outputted from the reference voltage output section 406 at the positive input, and receives the potential at a device side end of the resistance 212 positioned near the electronic device 50 at the negative input. Then, the comparator 414 compares the reference voltage and the potential at the device side end. By receiving an output voltage from the low pass filter 402 via the offset adder section 450 and the reference voltage output section 406, the difference detection section 412 may detect a potential difference between the output voltage of the low pass filter 402 having been adjusted by the offset adder section 450, and the potential at the device side end of the resistance 212. Then the comparator 414 supplies the result of comparing them to the reference voltage setting section 408 by means of a collector open output for example. For example, the comparator 414 opens the output when the potential of the positive input is larger than the potential of the negative input, and grounds the output when the potential of the positive input is smaller than the potential of the negative input.

Note that the device side end of the resistance 212 is connected to one end of the capacitor 216 in the present example. Accordingly, the potential of the device side end is equal to the terminal voltage Vo of the capacitor 216. When the function of Curbing the fluctuation of width of the hysteresis is not used, the comparator 414 may adopt a configuration of comparing the output voltage of the low pass filter 402 and the terminal voltage Vo.

The reference voltage setting section 408 includes a constant voltage source 508, and a plurality of resistances 510 and 518. The constant voltage source 508 outputs a predetermined voltage VCC1. The resistance 510 connects the positive pole of the constant voltage source 508 to the output end of the comparator 414. The resistance 518 connects the output end of the comparator 414 to the upstream end of the resistance 506 in the reference voltage output section 406.

When the terminal voltage Vo is smaller than the reference voltage, the comparator 414 opens the output. In this case, the reference voltage setting section 408 supplies the output voltage VCC1 of the constant voltage source 508 to the upstream end of the resistance 506 via the resistances 510 and 518. Accordingly, the reference voltage output section 406 outputs a first reference voltage VH to the positive input of the comparator 414, where the first reference voltage VH is determined based on the output of the offset adder section 450, the electric resistance ratio of the resistances 502, 504, 506, 510, and 518, and the output voltage VCC1 of the constant voltage source 508. In this case, when the voltage fall caused by the resistance 502 is assumed to be a first reference potential difference V(R11)H, then the first reference voltage VH corresponds to a voltage obtained by subtracting the first reference potential difference V(R11)H from the output voltage of the offset adder section 450.

When the terminal voltage Vo is larger than the reference voltage, the comparator 414 grounds the output. In this case, the reference voltage setting section 408 grounds the upstream end of the resistance 506 via the resistance 518. Consequently, due to decrease in the potential of the upstream end of the resistance 506, the reference voltage output section 406 outputs the second reference voltage VL to the positive input of the comparator 414, where the second reference voltage VL is smaller than the first reference voltage VH and is determined based on the output from the offset adder section 450 as well as the electric resistance ratio of the resistances 502, 504, 506, and 518. In this case, when the voltage fall caused by the resistance 502 is assumed to be a second reference potential difference V(R11)L, the second reference voltage VL corresponds to a voltage obtained by subtracting the second reference potential difference V(R11)L from the output voltage of the offset adder section 450.

Consequently, the reference voltage setting section 408 controls the reference voltage output section 406 to output the second reference voltage VL when the terminal voltage Vo of the capacitor 216 gets larger than the first reference voltage VH, based on the output of the comparator 414. On the contrary when the terminal voltage Vo gets smaller than the second reference voltage VL, the reference voltage setting section 408 controls the reference voltage output section 406 to output the first reference voltage VH. Accordingly, the reference voltage output section 406 outputs the reference voltage that changes by having a hysteresis, based on the output from the reference voltage setting section 408.

The reference voltage setting section 408 supplies the potential Va of a node between the resistance 510 and the resistance 518 to the load driving section 410 via the delay section 452. Accordingly, when the terminal voltage Vo of the capacitor 216 is smaller than the reference voltage outputted from the reference voltage output section 406, the reference voltage setting section 408 supplies a signal of H level to the load driving section 410 in accordance with the output from the comparator 414. As a result, the comparator 414 is able to Output a power current increase signal of H level to the output signal line when the terminal voltage Vo is smaller than the reference voltage.

On the other hand, when the terminal voltage Vo is larger than the reference voltage, the reference voltage setting section 408 supplies a signal of L level to the load driving section 410. As a result, the comparator 414 is able to output a power current decrease signal of L level to the output signal line when the terminal voltage Vo is larger than the reference voltage.

The delay section 452 prevents overshoot of the terminal voltage Vo by delaying at least part of the signal supplied to the parallel load section 304 via the load driving section 410. When the delay section 452 is not used, the output from the difference detection section 412 may be directly connected to the load driving section 410.

The load driving section 410 is a reverse circuit for example, and reverses an output of the comparator 414 received via the reference voltage setting section 408 and supplies the result to the parallel load section 304. Accordingly, the load driving section 410 supplies a signal in accordance with the result of comparing the terminal voltage Vo of the capacitor 216 and the reference voltage, to the parallel load section 304. In the present example, when the terminal voltage Vo is larger than the reference voltage, the load driving section 410 outputs a power current decrease signal of H level obtained by reversing the power current decrease signal of the comparator 414. When the terminal voltage Vo is smaller than the reference voltage, the load driving section 410 outputs a power current increase signal of L level obtained by reversing the power current increase signal of the comparator 414. Accordingly, the difference detection section 412 detects a potential difference between the output voltage from the low pass filter 402 after having been adjusted by the offset adder section 450 and the terminal voltage Vo of the capacitor 216, and notifies the parallel load section 304 of the detection result as either a power current increase signal or a power current decrease signal.

The parallel load section 304 is connected to the output end of the power current Output section 302 so as to be in parallel with the resistance 212. The parallel load section 304 consumes a partial power current being a part of the output power current from the power current output section 302 when receiving a power current decrease signal, and when receiving a power current increase signal, stops receiving the partial power current from the power current Output section 302. The parallel load section 304 includes a low-speed switch 512, a resistance 514, and a high-speed switch 516.

The low-speed switch 512 opens and closes in lower speed than the response speed of the power current output section 302. Because one end of the low-speed switch 512 is connected to the connection line 206, the low-speed switch 512 is connected in parallel to the resistance 212. The low-speed switch 512 opens and closes in accordance with an instruction from the control section 110, for example. As a result, the control section 110 is able to switch between ON/OFF of an operation of stabilizing the power supply voltage of the electronic device 50.

Here, the response speed of the power current output section 302 is for example a speed in which the power current output section 302 changes the output power current relative to the change in the power supply current Io received by the electronic device 50. The low-speed switch 512 may be a semiconductor switch such as a MOSFET. In this case, the low-speed switch 512 may receive an output SW from the control section 110 via a resistance for example.

The resistance 514 is connected in series with the low-speed switch 512 in the downstream of the low-speed switch 512. The resistance 514 consumes a power current received from the power current output section 302 via the high-speed switch 516.

The high-speed switch 516 is connected in series with the resistance 514 in the downstream of the resistance 514. The high-speed switch 516 is an N-type MOSFET that receives, at a gate terminal thereof, an output from the load driving section 410. The high-speed switch 516 opens and closes according to an output from the difference detection section 412. Here, the high-speed switch 516 opens and closes in higher speed than the response speed of the power current output section 302. When the terminal voltage Vo of the capacitor 216 is larger than the reference voltage, the high-speed switch 516 is brought ON by receiving a power current decrease signal. On the contrary, when the terminal voltage Vo is smaller than the reference voltage, the high-speed switch 516 is brought OFF by receiving a power current increase signal. The high-speed switch 516 may be connected both in parallel with the resistance 212 and in series with the low-speed switch 512.

When the low-speed switch 512 and the high-speed switch 516 are both ON, a partial power current IL being a part of the output power current of the power current output section 302 runs through the resistance 514, and the parallel load section 304 consumes this partial power current IL. Consequently, when the terminal voltage Vo is raised, the power current consumption section 306 decreases the power current running through the resistance 212, thereby lowering the terminal voltage Vo. When the high-speed switch 516 is brought OFF, the parallel load section 304 stops consuming the partial power current IL. As a result, when the terminal voltage Vo is lowered, the power current consumption section 306 increases the power current running through the resistance 212, thereby raising the terminal voltage Vo. In this way, the test apparatus 100 is able to maintain the power supply voltage for the electronic device 50 stable.

Note that if for example an output power current of the power current output section 302 is supplied to the electronic device 50 without use of the power current consumption section 306, there are cases where the terminal voltage Vo of the capacitor 216 changes largely in response to change in the power supply current Io for the electronic device 50. For example, when the power supply current Io is temporarily increased, the terminal voltage Vo may be temporarily lowered largely, due to undershoot. On the contrary when the power supply current Io is temporarily decreased, the terminal voltage Vo may be temporarily raised largely, due to overshoot. In such cases, the power supply voltage for the electronic device 50 becomes unstable, thereby making it difficult to conduct a test thereto appropriately. In addition, recent advancement in nanotechnologies has reduced the gate resistance of the MOSFET for example, and so it is possible that the electronic device 50 breaks due to overshoot of the power supply voltage.

However, by utilizing the power current consumption section 306, the present example is able to change the power current running from the power current output section 302 to the capacitor 216 appropriately according to the change in the power supply current Io of the electronic device 50. Accordingly, the power supply voltage to the electronic device 50 is able to be maintained stable in the present example.

Moreover, a test apparatus requires a multitude of connection lines 206, and so it is occasionally difficult to enlarge the wiring width for the connection line 206 from the reason of the implementation limitation for example. Likewise, it is occasionally difficult to arrange the power current output section 302 in the immediate vicinity of the electronic device 50. In such cases, even when the output voltage from the power current output section 302 is to be corrected by returning, as a feedback, the terminal voltage Vo of the capacitor 216, the response speed of the power current output section 302 has a limitation that it is based on the inductance of the connection line 206 for example. However the present example switches ON/OFF of the high-speed switch 516 thereby enabling to change the power current received by the capacitor 216 adequately and speedily.

Furthermore there are cases where the power supply voltage of an electronic device 50 differs depending on test items and according to types of the electronic device 50 for example. Accordingly, it is required to change the reference voltage to be supplied to the comparator 414 in accordance with the power supply voltage of the electronic device 50. Here, if the reference voltage is to be outputted to a device power source other than the power current output section 302, there may be cases where a sufficient accuracy cannot be obtained due to an error caused for example between test apparatuses and between user interfaces. If a correction circuit is independently provided for the purpose of correcting such an error, the circuit size will accordingly increase.

However according to the present example, the reference voltage output section 406 generates the reference voltage based on the output voltage from the power current output section 302. Consequently, in the present example the reference voltage is generated adequately even when the power supply voltage for the electronic device 50 is changed.

Furthermore in the present example, the difference detection section 412 receives an output voltage from the power current output section 302 via the offset adder section 450 and the low pass filter 402. By doing so, for example when the potential Vi at the power source side end of the resistance 212 is changed temporarily in response to the change in the power supply current Io, the reference voltage is generated stably. Here, suppose when the low pass filter 402 has a cutoff frequency of about 2 kHz and the potential Vi of the power source side end is changed by about 100 mV. In this case, so as to generate output fluctuation of about 1 mV, the low pass filter 402 has to have characteristics of about −40 db for example.

In this case, for the low pass filter 402 having a single stage configuration for RC such as in the present example, the frequency for yielding −3 db is 20 Hz, and the time constant τ of the RC will be about 8 m second. When for example the power supply voltage to be given to the electronic device 50 is changed, the settling time required to stabilize the reference voltage in the accuracy of about 0.1% is for example about 6.9×τ=55 m second, which means only a little impact on the test time.

When the power supply current Io of the electronic device 50 is 1A, and the capacitance of the capacitor 216 is 30 μF, the terminal voltage Vo of the capacitor 216 decreases by about 3 mV for 100 n second for example. In this case, it is possible to use for example an inexpensive general-purpose comparator as the comparator 414.

In different examples, the parallel load section 304 may include a plurality of resistances 514 selectable by switching therebetween or the like, for example. In this case, the control section 110 may select one resistance 514 depending on the type of the electronic device 50 or the like, and the low-speed switch 512 and the high-speed switch 516 may be connected to the selected resistance 514. Still further, the parallel load section 304 may utilize a constant power current circuit in place of the resistance 514.

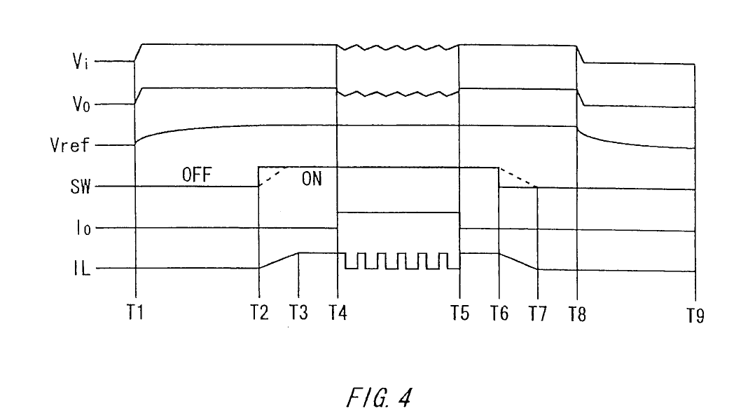

FIG. 4 is a timing chart showing one example of the operation performed by the power current consumption section 306 according to the present embodiment. In the present example, a power supply voltage to be supplied to the electronic device 50 is set to the power current output section 302. The power current output section 302 starts operating at the time T1, to start outputting the power supply voltage. In response to this, the power current consumption section 306 also starts operating. After the output voltage Vp from the low pass filter 402 has become stable, at the time T2, the control section 110 switches the signal SW to bring the low-speed switch 5120N. In response, the parallel load section 304 starts consuming the partial power current IL. The control section 110 may bring the low-speed switch 5120N after the output voltage Vref from the low pass filter 402 becomes substantially equal to the Output voltage from the power current output section 302.

It should be noted that the low-speed switch 512 may be gradually brought ON by receiving the signal SW via a resistance for example, as shown in the dotted line in the drawing. The parallel load section 304 may gradually increase the partial power current IL over a period from T2 to T3.

After waiting till the time T4 when the low-speed switch 512 has been stabilized, a test for the electronic device 50 will start. During this test, the terminal voltage Vo of the capacitor 216 changes according to the operation by the electronic device 50. In response, the difference detection section 412 outputs a power current increase signal and a power current decrease signal for stabilizing the terminal voltage Vo. According to these signals, the high-speed switch 516 is brought either ON or OFF depending on the change in the terminal voltage Vo, so that the parallel load section 304 consumes the partial power current IL accordingly. In this way, the power current consumption section 306 stabilizes the power supply voltage of the electronic device 50.

After the test for the electronic device 50 ends at the time T5, the low-speed switch 512 is brought OFF over a period from T6 to T7. Thereafter, after waiting till the time T8 for stabilization of the low-speed switch 512, the power current output section 302 lowers the output voltage to 0. Then, after the output voltage Vref of the low pass filter 402 is lowered in response, at the time T9, the power current consumption section 306 ends operating. Note that after once stopping the power current consumption section 306, the test apparatus 100 may start the next test after waiting for the low pass filter 402 to be stabilized. According to the present example, it becomes possible to maintain the power supply voltage Vo of the electronic device 50 stable.

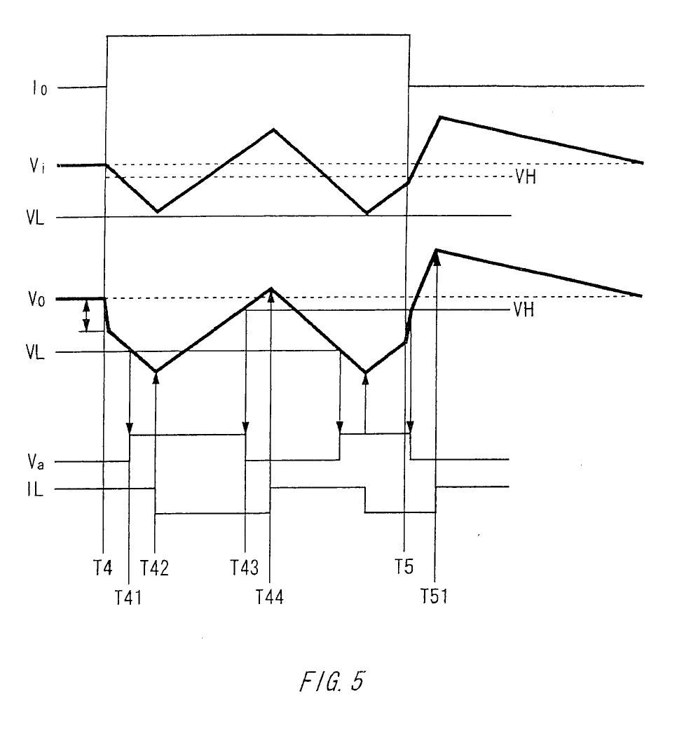

FIG. 5 is a timing chart showing one example of a detailed operation performed by the power current consumption section 306 during a period from T4 to T5. During this period, the terminal voltage Vo of the capacitor 216 repeats increase/decrease according to the operation of the electronic device 50.

Here, the reference voltage output section 406 outputs either the first reference voltage VH or the second reference voltage VL depending on the output Va from the comparator 414. For example in a period from T4 to T41 during which the terminal voltage Vo is larger than the second reference voltage VL, the comparator 414 supplies a power current decrease signal of L level to the parallel load section 304. Because the parallel load section 304 consumes the partial power current IL in response to reception of the power current decrease signal, the terminal voltage Vo gradually decreases.

On the other hand, for example at the time T41 when the terminal voltage Vo gets smaller than the second reference voltage VL, the comparator 414 reverses the output Va to H level, thereby supplying a power current increase signal. Then at the time T42 slightly later than the time T41, the parallel load section 304 stops consuming the partial power current IL according to the output from the load driving section 410.

In such a case, in a period until the terminal voltage Vo becomes larger than the first reference voltage VH after once getting smaller than the second reference voltage VL, the parallel load section 304 may stop running the partial power current IL to a path that is parallel to the resistance 212. The parallel load section 304 may stop receiving the partial power current IL from the power current output section 302 in case when the potential difference detected by the difference detection section 412 gets larger than a predetermined value.

Next, while the terminal voltage Vo is smaller than the first reference voltage VH (e.g. during a period from T42 to T43), the comparator 414 supplies a power current increase signal of H level to the parallel load section 304. In this occasion, the power current running from the power current output section 302 to the capacitor 216 increases, thereby raising the terminal voltage Vo of the capacitor 216.

Then for example at the time T43 when the terminal voltage Vo gets larger than the first reference voltage VH, the comparator 414 reverses the output Va to L level, thereby supplying a power current decrease signal. At the time T44 later than the time T43, the parallel load section 304 starts consuming the partial power current IL, in response to reception of the power current decrease signal delayed by the delay section 452. In this occasion, the power current running from the power current output section 302 to the capacitor 216 decreases, thereby lowering the terminal voltage Vo of the capacitor 216.

In a period until the terminal voltage Vo of the capacitor 216 becomes smaller than the second reference voltage VL after once getting larger than the first reference voltage VH due to the output of the comparator 414, the parallel load section 304 may consume the partial power current IL by running it to a path that is parallel to the resistance 212. The parallel load section 304 may consume the partial power current IL if the potential difference detected by the difference detection section 412 is smaller than a predetermined value.

As a result, the power current consumption section 306 stabilizes the terminal voltage Vo of the capacitor 216 within an adequate range. Consequently, it becomes possible to maintain the power supply voltage of the electronic device 50 stable according to the present embodiment.

Also when the terminal voltage Vo of the capacitor 216 is raised (e.g. at the time T51) after once the test completes at the time T5, the parallel load section 304 starts consuming the partial power current IL. Accordingly, it becomes possible to prevent the terminal voltage Vo from being raised in excess.

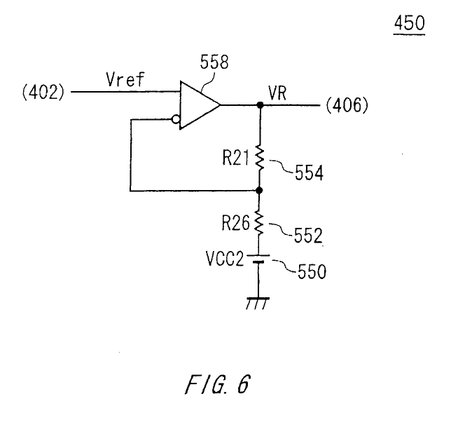

FIG. 6 shows a configuration of the offset adder section 450 according to the present embodiment. The offset adder section 450 includes a constant voltage source 550, a resistance 552, a resistance 554, and an operation amplifier 558. The constant voltage source 550 supplies a third reference voltage VCC2 that is higher than the output voltage Vref of the low pass filter 402. The resistance 552 is connected to the third reference voltage VCC2. The resistance 554 is connected between an end of the resistance 552 to which the third reference voltage VCC2 is not connected and an output end of the operation amplifier 558 being the output of the offset adder section 450.

The operation amplifier 558 is one example of a second comparator according to the present invention. The operation amplifier 558 receives input of the output voltage Vref of the low pass filter 402 as the positive input, and the voltage at the junction between the resistance 552 and the resistance 554 as the negative input. The operation amplifier 558 decreases the output voltage of the offset adder section 450 when the voltage at the junction is larger than the output voltage Vref of the low pass filter 402. On the contrary, when the voltage at the junction is smaller than the output voltage of the low pass filter 402, the operation amplifier 558 decreases the output voltage of the offset adder section 450.

The output voltage VR from the offset adder section 450 is stabilized when the voltage at the junction between the resistance 552 and the resistance 554 inputted to the negative input of the operation amplifier 558 is equaled to the output voltage Vref of the low pass filter 402 inputted to the positive input of the operation amplifier 558. Here, because the third reference voltage VCC2 is higher than the output voltage Vref from the low pass filter 402, the voltage fall caused by the resistance 552 will decrease as the output voltage Vref from the low pass filter 402 becomes high. As a consequence, because the voltage fall of the resistance 554 is determined by a resistance ratio between the resistance 552 and the resistance 554, the voltage fall caused by the resistance 554 decreases as the output voltage Vref from the low pass filter 40′ becomes high. Accordingly, when the output voltage Vref from the low pass filter 402 is higher, the offset adder section 450 outputs a voltage VR obtained by subtracting a slight voltage fall from the output voltage Vref, i.e. the VR is obtained by adding a negative offset voltage nearer to 0 to the output voltage Vref. Conversely, when the output voltage Vref from the low pass filter 402 is smaller, the offset adder section 450 outputs a voltage VR obtained by subtracting a large voltage fall from the output voltage Vref, i.e. the VR is obtained by adding a negative offset voltage that is farther from 0 to the output voltage Vref. By utilizing the operation amplifier 558, it becomes possible to stabilize the output voltage VR even without independently providing a voltage follower between the offset adder section 450 and the reference voltage output section 406.

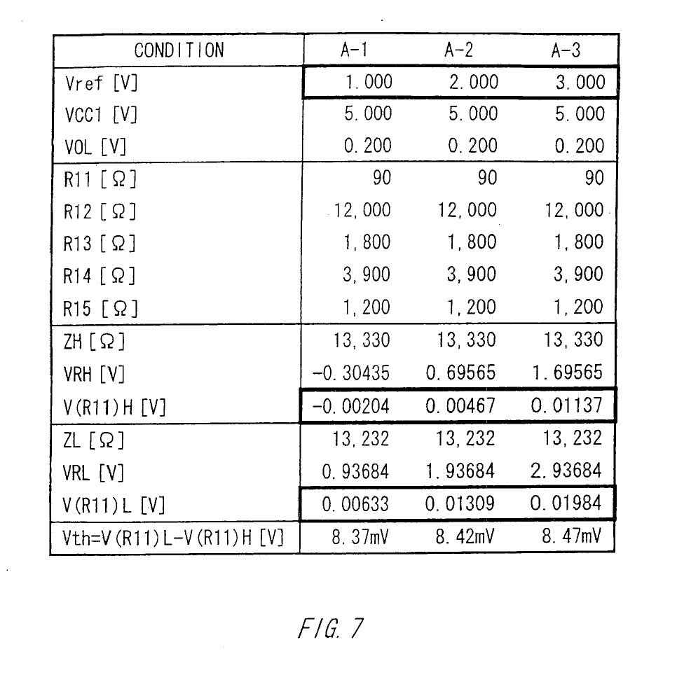

FIG. 7 shows an example in which a reference potential difference for a test apparatus 100 without the offset adder section 450 is calculated. In the test apparatus 100 without the offset adder section 450, the output voltage Vref from the low pass filter 402 is directly inputted to the reference voltage output section 406. As follows, the differential voltage between the output voltage Vref from the low pass filter 402 and the reference voltage inputted to the comparator 414 (i.e. the voltage fall caused by the resistance 502) is shown for each of cases where the output from the comparator 414 is H level and L level respectively, with reference to the circuits in the difference detection section 412 as shown in FIG. 3. Note that in the present embodiment, the mentioned differential voltage obtained by subtracting the reference voltage of the comparator 414 from the input voltage of the reference voltage output section 406 is referred to as “reference potential difference”.

(1) when the output from the comparator 414 is H level (power current increase signal)

When the output voltage VCC1 of the constant voltage source 508 is set as 0V, the equivalent impedance ZH up to the ground point viewed from the resistance 502 is represented by the following expression (1).

(Expression 1)
ZH=R12+(R13×(R14+R15)/(R13+R14+R15)) (1)

In this expression, R12 represents a resistance value of the resistance 504, R13 represents a resistance value of the resistance 506, R14 represents a resistance value of the resistance 518, and R15 represents a resistance value of the resistance 510.

In the case of having subtracted the potential difference caused at both ends of the resistance 506 attributable to the constant voltage source 508, the equivalent voltage VRH between the resistance 502 and the offset adder section 450 is represented by the following expression (2).

(Expression 2)
VRH=Vref−(VCC1×R13/(R13+R14+R15)) (2)

In the case of changing the output of the comparator 414 from H level to L level, the differential voltage (Vref−Vin) for the resistance 502 will be equal to a voltage fall V(R11)H by the resistance 502 (i.e. the first reference potential difference) and is represented as the following expression (3).

$$\begin{matrix}( Expression 3 ) & \\ \begin{matrix}V ( R 11 ) H = VRH \times R 11 / ( ZH + R 11 ) \\ = ( Vref - ( VCC 1 \times R 13 / ( R 13 + R 14 + R 15 ) ) ) \times \\ R 11 / ( ZH + R 11 ) \\ = Vref \times [ R 11 / ( ZH + R 11 ) ] - VCC 1 \times \\ [ ( R 13 / ( R 13 + R 14 + R 15 ) ) \times R 11 / ( ZH + R 11 ) ]\end{matrix} & ( 3 )\end{matrix}$$

Here, because the first reference potential difference V(R11)H becomes positive, the first term becomes larger than the second term. In addition, the second term remains as a constant value even if the output voltage Vref from the low pass filter 402 changes. Accordingly, because the first term changes as a result of the change in the output voltage Vref of the low pass filter 402, the first reference potential difference V(R11)H will fluctuate.

(2) when the output from the comparator 414 is L level (power current decrease signal)

When the output from the comparator 414 is set as L level (voltage VOL), the equivalent impedance ZL up to the ground point viewed from the resistance 502 is represented by the following expression (4).

(Expression 4)
ZL=R12+(R13×R14)/(R13+R14) (4)

In the case of having subtracted the potential difference caused at both ends of the resistance 506 attributable to the voltage VOL of the comparator 414, the equivalent voltage VRL between the resistance 502 and the offset adder section 450 is represented by the following expression (5).

(Expression 5)
VRL=Vref−(VOL×R13/(R13+R14)) (5)

In the case of changing the output of the comparator 414 from L level to H level, the differential voltage (Vref−Vin) for the resistance 502 will be equal to a voltage fall V(R11)L by the resistance 502 (i.e. the second reference potential difference) and is represented by the following expression (6).

$$\begin{matrix}( Expression 6 ) & \\ \begin{matrix}V ( R 11 ) L = VRL \times R 11 / ( ZL + R 11 ) \\ = ( Vref - ( VOL \times R 13 / ( R 13 + R 14 ) ) \times \\ R 11 / ( ZL + R 11 ) \\ = Vref \times [ R 11 / ( ZH + R 11 ) ] - \\ VOL \times [ ( R 13 / ( R 13 + R 14 ) ) \times R 11 / ( ZL + R 11 ) ]\end{matrix} & ( 6 )\end{matrix}$$

Here, because the first reference potential difference V(R11)L becomes positive, the first term becomes larger than the second term. In addition, the second term remains as a constant value even if the output voltage Vref from the low pass filter 402 changes. Accordingly, because the first term changes as a result of the change in the output voltage Vref of the low pass filter 402, the first reference potential difference V(R11)L will fluctuate.

As shown in FIG. 7, in a test apparatus 100 without the offset adder section 450, although the difference Vth between the first reference potential difference V(R11)H and the second reference potential difference V(R11)L is substantially constant regardless of the output voltage Vref from the low pass filter 402, their respective values change largely depending on the output voltage Vref from the low pass filter 402. As a result, in a test of changing the power supply voltage Vo or the like, the stability of the power supply voltage changes according to the change in power Supply voltage supplied to the electronic device, which makes it hard to perform the test accurately.

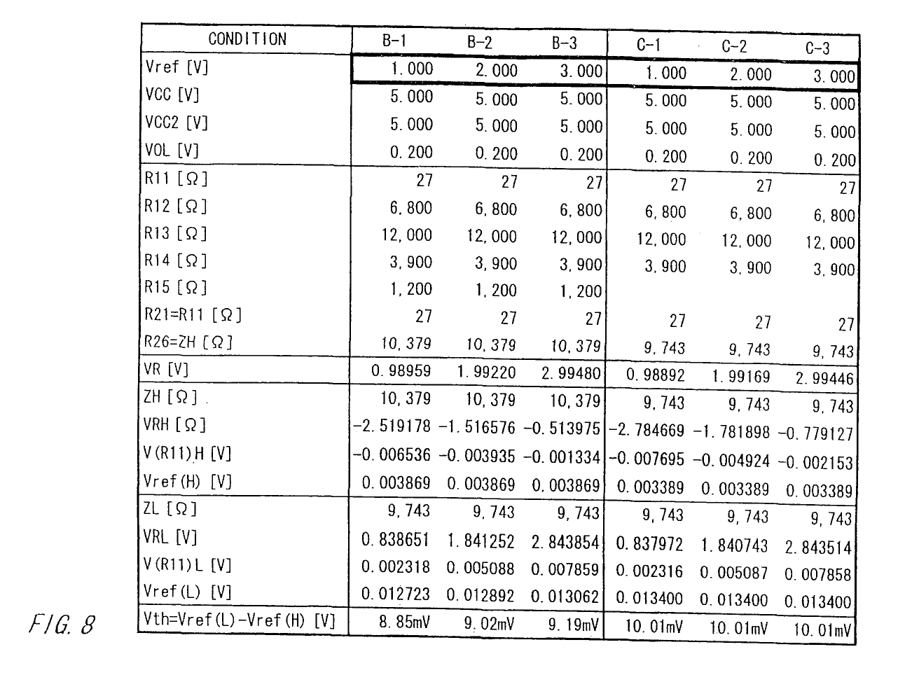

FIG. 8 shows an example in which a reference potential difference in the test apparatus 100 is obtained according to the present embodiment. Hereinafter, by referring to the circuits of the difference detection section 412 in FIG. 3 and the offset adder section 450 in FIG. 6, the differential voltage between the output voltage Vref from the low pass filter 402 and the reference voltage inputted to the comparator 414 is shown for cases where the output from the comparator 414 is H level and L level respectively.

(1) when the Output from the comparator 414 is H level (power current increase signal)

Because the voltage at the connection point between the resistance 552 and the resistance 554 in the stable state is Vref, the output voltage VR of the offset adder section 450 is represented by the following, expression (7).

(Expression 7)
VR=Vref−(VCC2−Vref)×(R21/R26) (7)

In the test apparatus 100 having the offset adder section 450, the output voltage VR from the offset adder section 450 is inputted to the reference voltage output section 406 instead of the output voltage Vref from the low pass filter 402. In this case, the equivalent voltage VRH between the resistance 502 and the offset adder section 450 is obtained by substituting VR in the Vref of the expression (2). Accordingly, when the output from the comparator 414 is changed from H level to L level, the differential voltage Vref (H) between the output voltage Vref from the low pass filter 402 and the reference voltage inputted to the comparator 414 is represented by the following expression (8).

$$\begin{matrix}[ Expression 8 ] & \\ \begin{matrix}Vref ( H ) = Vref - VR + V ( R 11 ) H \\ = Vref \times ( ( R 11 / ( ZH + R 11 ) - ( R 21 / R 26 ) \times \\ ( ZH / ( ZH + R 11 ) ) ) + VCC 2 \times ( R 21 / R 26 ) \times \\ ( ZH / ( ZH + R 11 ) ) - VCC 1 \times \\ ( R 13 / ( R 13 + R 14 + R 15 ) ) \times ( R 11 / ( ZH + R 11 ) )\end{matrix} & ( 8 )\end{matrix}$$

The first expression in the expression (8) can be transformed into the following expression (9).

(Expression 9)
Vref(H)=V(R11)H−(VR−Vref) (9)

Here, the offset adder section 450 adds a negative offset voltage (VR−Vref) to the output voltage Vref of the low pass filter 402, and outputs the result as the output voltage VR of the offset adder section 450. As can be seen from this, the differential voltage Vref (H) corresponds to a value obtained by subtracting an offset voltage of the offset adder section 450 from the first reference potential difference V(R11)H. Accordingly, the offset adder section 450 increases the offset voltage when the first reference potential difference is increased according to the change in output voltage of the low pass filter 402, and on the contrary decreases the offset voltage when the first reference potential difference is decreased. Accordingly, the fluctuation of the differential voltage Vref (H) is restrained. It is desirable that the offset adder section 450 adjusts the offset voltage so that the amount of fluctuation for the first reference potential difference becomes substantially the same as the amount of fluctuation for the offset voltage.

Next, the condition for setting the fluctuation of the differential voltage Vref (H) as 0 is shown. In the expression (8), the second term and the third term remain constant even if the output voltage Vref from the low pass filter 402 changes. Accordingly, so as to maintain Vref (H) constant regardless of the change of the output voltage Vref of the low pass filter 402, the first term may be set to 0. For realizing such, the resistance values of the resistance 552 and the resistance 554 within the offset adder section 450 may be defined so that the relation of R21/R26=R11/ZH holds. In addition, each resistance value may be set to a value that yields a positive value for (second term−third term).

(2) when the output from the comparator 414 is L level (power current decrease signal)

As described above, in the test apparatus 100 having the offset adder section 450, the output voltage VR of the offset adder section 450 is inputted to the reference voltage output section 406, instead of the output voltage Vref from the low pass filter 402. In this case, the equivalent voltage VRL between the resistance 502 and the offset adder section 450 is obtained by substituting the VR in the Vref of the expression (5). Accordingly, in the case of changing the output of the comparator 414 from L level to H level, the differential voltage Vref (L) between the output voltage Vref of the low pass filter 402 and the reference voltage inputted to the comparator 414 is represented by the following expression (10).

$$\begin{matrix}[ Expression 10 ] & \\ \begin{matrix}Vref ( L ) = Vref - VR + V ( R 11 ) L \\ = Vref \times ( ( R 11 / ( ZL + R 11 ) - ( R 21 / R 26 ) \times \\ ( ZL / ( ZL + R 11 ) ) ) + VCC 2 \times ( R 21 / R 26 ) \times \\ ( ZL / ( ZL + R 11 ) ) - VOL \times \\ ( R 13 / ( R 13 + R 14 ) ) \times ( R 11 / ( ZL + R 11 ) )\end{matrix} & ( 10 )\end{matrix}$$

As mentioned in the item (1), the first expression in the expression (10) can be transformed into the following expression (11).

(Expression 11)
Vref(L)=V(R11)L−(VR−Vref) (11)

From the expression (11), it is understood that the differential voltage Vref (H) is obtained by subtracting the offset voltage of the offset adder section 450 from the second reference potential difference V(R11)L. Accordingly, the offset adder section 450 is able to restrain the fluctuation of the differential voltage Vref (L) by raising the offset voltage when the second reference potential difference is increased according to the change in output voltage of the low pass filter 402, and lowering the offset voltage when the second reference potential difference is decreased. It is desirable that the offset adder section 450 adjusts the offset voltage so that the amount of fluctuation for the second reference voltage potential becomes substantially the same as the amount of fluctuation of the offset voltage.

Next, the condition for setting the fluctuation of the differential voltage Vref (L) as 0 is shown. In the expression (11), the second term and the third term remain constant even if the output voltage Vref from the low pass filter 402 changes. Accordingly, so as to maintain the Vref (L) constant regardless of the change of the output voltage Vref of the low pass filter 402, the first term may be set to 0. For realizing such, the resistance values of the resistance 552 and the resistance 554 within the offset adder section 450 may be defined so that the relation of R21/R26=R11/ZL holds. In addition, each resistance value may be set to a value that yields a positive value for (second term−third term).

In the above, ZH includes R15 as a parameter, whereas ZL does not include R15 as a parameter. Accordingly, unless R15 is 0, it is impossible to set as 0 for both of the fluctuations for the Vref (H) and Vref (L) that depend on the output voltage Vref of the low pass filter 402. Accordingly, the resistance values for the resistance 552 and the resistance 554 within the offset adder section 450 may be set so as to minimize the fluctuation widths of Vref (H) and Vref (L) that depend on the output voltage Vref. The resistance value R15 of the resistance 502 may be set as a smaller value than the resistance value R14 of the resistance 518. Alternatively, it is also possible to set, as 0, the fluctuation widths for both of Vref (H) and Vref (L) that depend on the output voltage Vref from the low pass filter 402, by using a comparator of voltage output type as the comparator 414 to dispense with the resistance 510 and the constant voltage source 508.

The conditions B-1-B-3 in FIG. 8 show a relationship among the output voltage Vref, Vref (H), and Vref (L), when the fluctuation width of Vref (H) that depends on the change in the output voltage Vref from the low pass filter 402 is set as 0 by setting R21/R26=R11/ZH. As shown in FIG. 8, the test apparatus 100 uses the offset adder section 450 to restrain the fluctuations of the differential voltage between the output voltage Vref of the low pass filter 402 and the first reference voltage VRH or the second reference voltage VRL, even when the first reference voltage V(R11)H and the second reference voltage V(R11)L change according to the change in the output voltage Vref of the low pass filter 402. In addition, the conditions C-1-C-3 in FIG. 8 show a relationship among the output voltage Vref, Vref (H), and Vref (L), when a voltage output type comparator is used as the comparator 414. As shown in FIG. 8, by adopting a voltage output type comparator as the comparator 414, the test apparatus 100 is able to eliminate the effect of the resistance 510. Consequently, such a test apparatus 100 is able to set, as substantially 0, the fluctuation of the differential voltage between the output voltage Vref of the low pass filter 402 and the first reference voltage VRH as well as the fluctuation between the output voltage Vref of the low pass filter 402 and the second reference voltage VRL, even when the first reference voltage V(R11)H and the second reference voltage V(R11)L change according to the change in the output voltage Vref of the low pass filter 402.

As shown above, the test apparatus 100 according to the present embodiment is able to restrain, to substantially 0, the fluctuation of both of the differential voltage Vref (H) between the output voltage Vref and the first reference voltage VH and the differential voltage Vref (L) between the output voltage Vref and the second reference voltage VL, even when the output voltage Vref from the low pass filter 402 is changed. Consequently, the test apparatus 100 is able to supply a stable power supply voltage even when the power supply voltage for the electronic device 50 is changed.

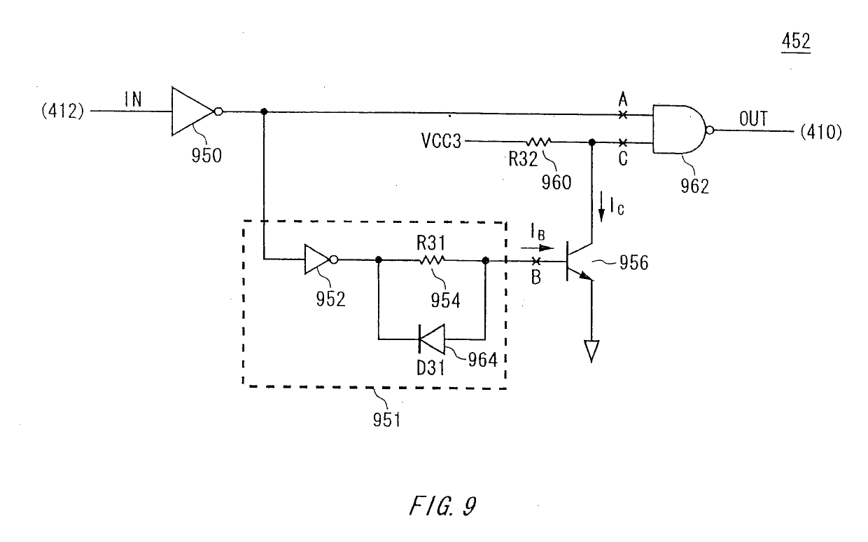

FIG. 9 shows a configuration of the delay section 452 according to the present embodiment. The delay section 452 changes the timing at which a power current decrease signal is started to be supplied to the parallel load section 304 according to a period since the difference detection section 412 starts to supply a power current increase signal and until starting to supply a power current decrease signal. More specifically, the delay section 452 delays the timing if the aforementioned period becomes longer.

The delay section 452 includes a NOT gate 950, a base power current supply section 951, a transistor 956, a resistance 960, and a NAND gate 962. The NOT gate 950 reverses a logic value of a power current increase signal and of a power current decrease signal, supplied from the output signal line of the difference detection section 412. As a result, the NOT gate 950 outputs a power current increase signal of L level and a power current decrease signal of H level.

The base power current supply section 951 supplies a first base power current to the transistor 956 when a power current decrease signal is being supplied from the difference detection section 412. On the contrary, when a power current increase signal is being supplied from the difference detection section 412, the base power current supply section 951 supplies a second base power current that is larger than the first base power current to the transistor 956. The base power current supply section 951 includes a NOT gate 952, a resistance 954, and a diode 964.

The NOT gate 952 is one example of the first gate according to the present invention. The NOT gate 952 outputs a signal of H level when the difference detection section 412 supplies a power current increase signal, and on the other hand outputs a signal of L level when a power current decrease signal is supplied. Accordingly, the NOT gate 952 prevents reflux of the power current at the base side of the transistor 956 into the output signal line of the NOT gate 950. The NOT gate 952 according to the present embodiment reverses a logic value of a power current increase signal and of a power current decrease signal outputted from the NOT gate 950.

The resistance 954 is provided between the output of the NOT gate 952 and the base of the transistor 956, and supplies a base power current that is based on the Output voltage of the NOT gate 952 and the voltage of the base of the transistor 956 to the base of the transistor 956. When the NOT gate 952 has outputted a power current decrease signal of L level, the resistance 954 lowers the base voltage by supplying a first base power current being a negative base power current. When the NOT gate 952 has outputted a power current increase signal of H level, the resistance 954 raises the base power current by supplying a second base power current that is larger than the first base power current to the transistor 956.

The diode 964 is provided in parallel to the resistance 954, and the output of the first gate and the cathode are respectively connected to the base of the transistor 956 and the anode. The diode 964 reduces a time delay required for bringing the transistor 956 OFF by means of the parasitic capacity of the transistor 956, when the output from the NOT gate 952 has changed from H level to L level. It is desirable that the diode 964 is a Schottky diode having a small forward voltage and operating at high speed.

The base of the transistor 956 is connected to the output of the diode 964, and the collector thereof is connected to the junction between the resistance 960 and the NAND gate 962, and the emitter thereof is connected to ground. The transistor 956 receives, at its base, input of the base power current supplied from the base power current supply section 951, and is saturated when receiving the second base power current. In other words, when receiving the second base power current, resistance values for the resistance 954 and the resistance 960 are determined so that the collector power current (IC)/the base power current (IB) is operated in a saturation area sufficiently smaller than the power current amplification factor “hfe” of the transistor 956. Accordingly, in the transistor 956, the time delay until the base power current is brought OFF after once switched to the first base power current increases, as the ON time during which the inputted second base power current is operated in the saturation area gets longer.

One end of the resistance 960 is connected to the constant voltage source VCC3, and the other end of the resistance 960 is connected to the collector of the transistor 956 and to one input of the NAND gate 962. The resistance 960 runs a collector power current Ic defined based on the voltage VCC3 and the resistance value of the resistance 960 to the transistor 956. In this case, the potential of the collector side of the transistor 956 becomes L level. When the transistor 956 is in the OFF state, the resistance 960 brings the potential of the collector side of the transistor 956 to H level.

The NAND gate 962 is one example of a power current control signal output section according to the present invention. The NAND gate 962 takes non-disjunction of the output of the NOT gate 950 and the potential of the collector of the transistor 956, and outputs the result to the load driving section 410. Accordingly, the NAND gate 962 supplies a power current increase signal of H level to the parallel load section 304, during an ON period of the transistor 956 that is composed of a period in which the transistor 956 is receiving the second base power current and a period in which the transistor 956 is saturated. In addition, in an OFF period in which the transistor 956 is receiving the first power current and the transistor 956 is not saturated, the NAND gate 962 supplies a power current decrease signal of L level to the parallel load section 304.

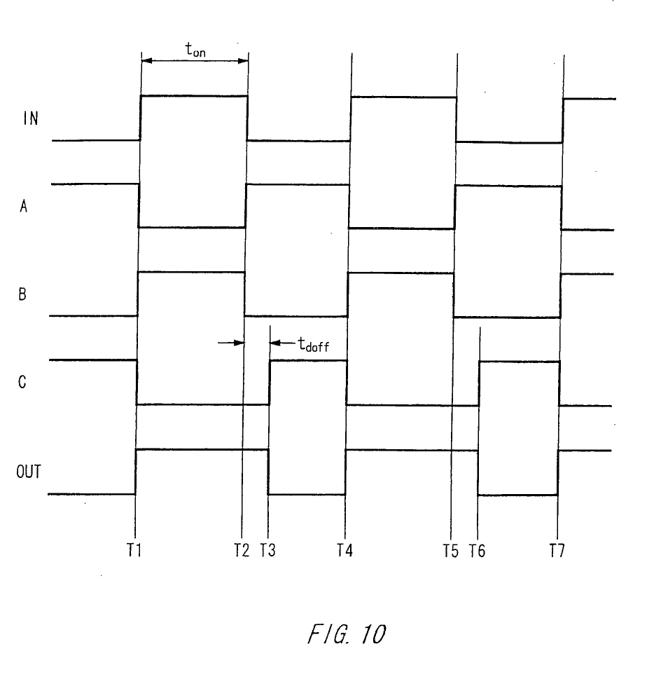

FIG. 10 is a timing chart showing one example of an operation performed by the delay section 452 according to the present embodiment. To the point A, the NOT gate 950 outputs a signal obtained by reversing the output of the difference detection section 412. To the point B, the NOT gate 952 outputs a signal obtained by reversing the output of the NOT gate 950 again.

During a period from T1 to T2, when receiving the power current increase signal of H level from the difference detection section 412, the potential at the point B becomes H level, and the second base power current is supplied to the transistor 956. Accordingly, the transistor 956 is brought ON, and is saturated. As a result, the point C becomes L level, and the NAND gate 962 outputs a power current increase signal of H level.

At the time T2, when the output of the difference detection section 412 is changed to a power current decrease signal of L level from a power current increase signal of H level, the transistor 956 is brought OFF after a time delay “tdoff” that is in accordance with the period “ton” during which the transistor 956 is receiving a second base power current. Note that during the time delay “tdoff”, the transistor 956 is in the saturation state even after receiving the power current decrease signal. Accordingly, until the time T3 and while the transistor 956 is in the saturation state, the point C is maintained as L level, and the NAND gate 962 keeps Outputting a power current increase signal of H level. Then after the time T3 and while the transistor 956 is receiving the first power current and is not saturated, the point A and the point C become H level, and so the NAND gate 962 outputs a power current decrease signal of L level.

At the time T4, when the output of the difference detection section 412 is changed to a power current increase signal of H level, the Output of the NOT gate 950 is reversed, to produce L level at the point A. Accordingly, the NAND gate 962 outputs a power current increase signal of H level after a short time delay defined by logic delay of the NOT gate 950 and the NAND gate 962 and the like has elapsed after the time T4.

When the period from a time when the difference detection section 412 has started supplying a power current increase signal to a time when the difference detection section 412 starts supplying a power current decrease signal is longer, the delay section 452 described above sets the time delay between a time when the difference detection section 412 has started supplying a power current decrease signal and a time when the power current decrease signal is supplied to the parallel load section 304 longer than the time delay between a time when the difference detection section 412 has started supplying a power current increase signal and a time when the power current increase signal is supplied to the parallel load section 304. As a result, the delay section 452 is able to delay the timing for switching the output from a power current increase signal of H level to a power current decrease signal of L level, to lengthening a period in which a power current increase signal is outputted to the output of the difference detection section 412.

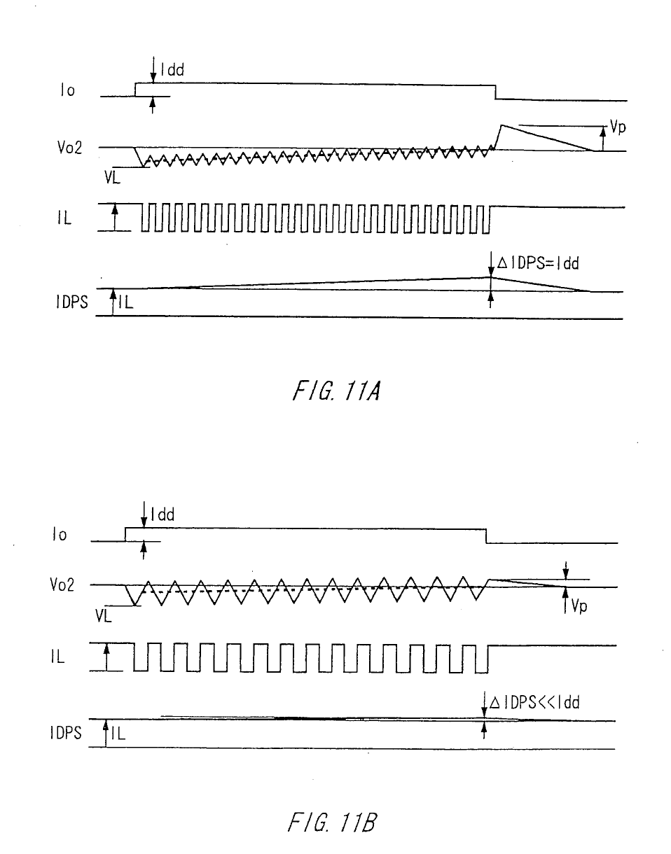

FIGS. 11(a) and 11(b) respectively show a relationship between an operation performed by the test apparatus 100 and the output power current of the power current output section 302 according to the present embodiment. When the power supply current Io of the electronic device 50 runs, the test apparatus 100 controls the terminal voltage Vo of the capacitor 216 so as to reside between the first reference voltage VH and the second reference voltage VL. The test apparatus 100 sets the first reference voltage VH and the second reference voltage VL lower than the power supply voltage of the electronic device 50 for stabilizing the operation. Consequently, the output voltage of the power current output section 302 fluctuates at lower voltages than the power supply voltage of the electronic device 50.

Here, the power current output section 302 achieves high accuracy by outputting the output voltage to the comparator by negative feedback. Then the power current output section 302 has a characteristic of gradually increasing the output power current until the output power voltage reaches the power supply voltage of the electronic device 50, because the output voltage from the power current output section 302 also fluctuates at lower voltages than the power supply voltage of the electronic device 50.

FIG. 11(a) is a timing chart showing a relationship between an operation of the test apparatus 100 without the delay section 452 and the Output power current from the power current output section 302. If the test apparatus 100 is without the delay section 452, immediately after the terminal voltage Vo of the capacitor 216 gets larger than the first reference voltage VH, the power current decrease signal outputted from the difference detection section 412 is supplied to the parallel load section 304 to start consumption of a partial power current. Accordingly, the power current output section 302 gradually increases the output power current IDPS because the average value of the output voltage Vo2 is lower than the power supply voltage of the electronic device 50 being a target voltage. As a result, the output power current IDPS supplied by the power current output section 302 is increased as the period during which the power supply current Io runs to the electronic device 50 becomes long.

Thereafter, when the power supply current Io for the electronic device 50 rapidly decreases, the power current output section 302 cannot lower the output power current IDPS with a good responsiveness and the parallel load section 304 cannot absorb all the output power current IDPS, leading to a large overshoot Vp at the output voltage Vo2 of the power current output section 302.

FIG. 11(b) is a timing chart showing a relationship between an operation of the test apparatus 100 equipped with the delay section 452 and the output power current of the power current output section 302. The delay section 452 supplies a power current decrease signal to the parallel load section 304 after the time delay that is according to the OFF period of the high-speed switch 516 has passed after the terminal voltage Vo of the capacitor 216 becomes larger than the first reference voltage VH. Accordingly, consumption of the partial power current starts from a time when the terminal voltage Vo of the capacitor 216 has become sufficiently larger than the first reference voltage VH. Accordingly, the average value of the output voltage Vo2 approaches the power supply voltage of the electronic device 50 being a target voltage, and so the power current output section 302 lowers the increased amount of the output power current IDPS. As a result, even if the period during which the power supply current Io runs to the electronic device 50 is long, increase in the output power current IDPS supplied by the power current output section 302 decreases compared to the case where the Lest apparatus 100 is not equipped with the delay section 452.

Accordingly, even when the power supply current Io for the electronic device 50 rapidly decreases, the parallel load section 304 is able to absorb the Output power current IDPS, and so it becomes possible to reduce the overshoot Vp of the output voltage Vo2.

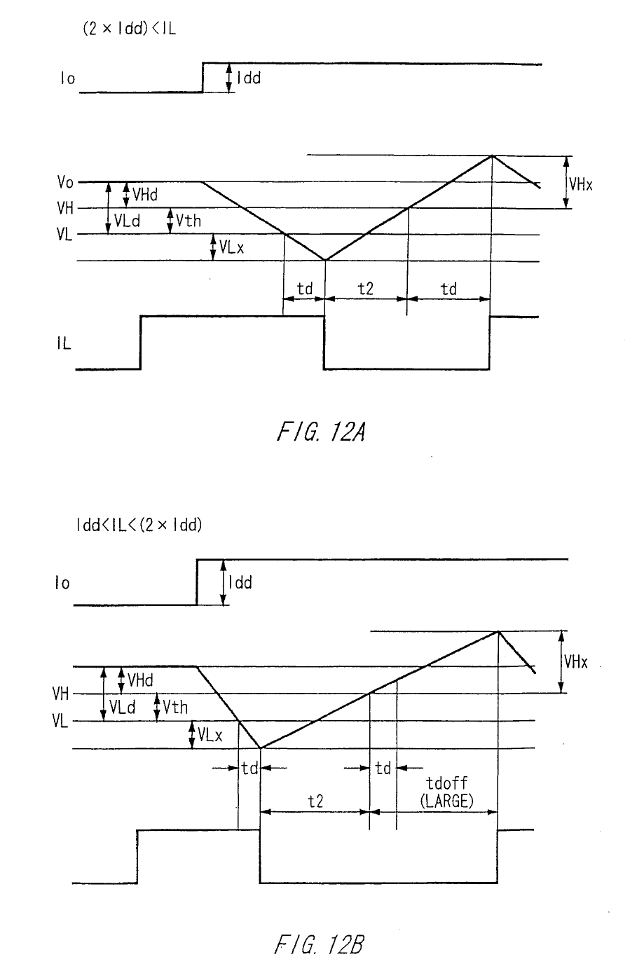

FIGS. 12(a) and 12(b) respectively show one example of a detailed operation performed by the test apparatus 100 by means of the delay section 452 according to the present embodiment. First, when the electronic device 50 is not consuming the power supply current Io, all the Output power current IDPS from the power current output section 302 is consumed by the parallel load section 304 as a partial power current IL.

Then when the electronic device 50 starts consuming the Idd[A] as the power supply current Io, the power current of Idd[A] starts running from the capacitor 214 and the capacitor 216, and the terminal voltage Vo starts lowering at a speed defined according to the total capacity value CL[F] for the capacitor 214 and the capacitor 216 and the value “Idd”. When the terminal voltage Vo gets smaller than the second reference voltage VL, the difference detection section 412 switches the output to the power current increase signal. Hereinafter, the difference between the power supply voltage Vo2 to be supplied to the electronic device 50 and the second reference voltage VL is referred to as VLd[V].

After the time delay “td” has elapsed after the difference detection section 412 switched the output to the power current increase signal, the high-speed switch 516 in the parallel load section 304 is brought OFF. Due to the delay in the power current increase signal by this time delay “td”, the power supply voltage Vo starts rising after further lowered by VLx[V] from the second reference voltage VL.

When the high-speed switch 516 is in the OFF state, a power current of (IL−Idd)[A] runs through the capacitor 214 and the capacitor 216, and the terminal voltage Vo starts rising at the speed defined according to the total capacity value CL for the capacitor 214 and the capacitor 216 and the value of (IL−Idd). When the terminal voltage Vo gets larger than the first reference voltage VH, the difference detection section 412 switches the output to the power current decrease signal. Hereinafter, the difference between Vo2 and the first reference voltage VH is represented as VHd[V].

After the time delay “tdoff” has elapsed after the difference detection section 412 switched the output to a power current decrease signal, the high-speed switch 516 in the parallel load section 304 is brought ON. Due to the delay in the power current decrease signal by this time delay “tdoff”, the power supply voltage Vo starts lowering after further raised by VHx[V] from the first reference voltage VH.

As shown in FIG. 12A, when (2×Idd) is smaller than IL, the relation of Idd<(IL−Idd) holds, and so the speed at which the terminal voltage Vo is raised is faster than the speed at which the terminal voltage Vo is lowered. Accordingly, even if the amount of delay “tdoff” by the delay section 452 is set as 0, the output voltage of the power current output section 302 reaches the power supply voltage to be supplied to the electronic device 50. Therefore the increase in the Output power current IDPS supplied from the power current output section 302 is small and so the overshoot Vp is small.

On the other hand, when Idd<IL<(2×Idd) holds as shown in FIG. 12B, the relation of Idd>(IL−Idd) holds, and so the speed at which the terminal voltage Vo is raised is slower than the speed at which the terminal voltage Vo is lowered. Accordingly, if there is no delay by the delay section 452, the output voltage from the power current output section 302 does not reach the power supply voltage to be supplied to the electronic device 50. In view of this, the delay section 452 delays a power current decrease signal by the time delay “tdoff”, to cause the output voltage of the power current output section 302 to reach the power supply voltage to be supplied to the electronic device 50. Accordingly, it becomes possible to restrain increase of the output power current IDPS supplied by the power current output section 302, and to reduce the overshoot Vp.

The time period t2 after the terminal voltage Vo starts rising till the terminal voltage Vo reaches the first reference voltage VH is obtainable using the following expression (12).

(Expression 12)
t2=CL×(VLx+Vth)/(IL−Idd) (12)

Note that “Vth” is a differential voltage between VL and VH.

The time delay “tdoff” for further raising the terminal voltage Vo by VHx after once reached to the first reference voltage VH is obtainable by the following expression (13).

(Expression 13)
tdoff=CL×VH×/(IL−Idd) (13)

The following expression (14) is obtained by the expression (12) and the expression (13).

(Expression 14)
tdoff/t2=VHx/(VLx+Vth) (14)

When the VHx, VLx, and Vth are determined using the expression (14), the value of “tdoff” according to t2 is calculated. Accordingly, by determining the resistance values for the resistance 954 and the resistance 960 that yield “tdoff” that either satisfies this relation or approximates to this relation, the delay section 452 becomes able to delay the power current decrease signal to an appropriate timing and to reduce the overshoot Vp.

Note that when the minimum value of the total capacity CL for the capacitor 214 and the capacitor 216 is defined based on the power supply current “Idd” for the electronic device 50, the time delay “Idd” for the operation performed by the parallel load section 304, and the allowable amount VLx of the voltage fall from the first reference voltage. More specifically, the minimum value of CL is obtainable based on the following expression (15).

(Expression 15)
CL=Idd×td/VLx (15)

For example, when “Idd” is 1A, “td” is 300 ns, and VLx is 10 mV, CL takes a value no less than 30 μF.

In the above, the present invention has been described by way of embodiments. However, it is needless to say that the technical scope of the present invention should not be limited by the above-described embodiment. It should be understood that those skilled in the art might make many changes and substitutions without departing from the spirit and the scope of the present invention. It is obvious from the appended claims that embodiments with such modifications also belong to the scope of the present invention.

The present invention provides a power supply apparatus that supplies a stable power supply voltage to an electronic device, and a test apparatus that tests an electronic device with high accuracy using the power supply apparatus.

What is claimed is:

1. A power supply apparatus that supplies a power supply current to an electronic device, the power supply apparatus comprising:
a power current output section that outputs an output power current that at least partially includes the power supply current;
a connection resistance that supplies, to the electronic device, the power supply current received from the power current output section, by electrically connecting the power current output section and the electronic device;
a low pass filter that has a cut-off frequency lower than a variety of frequencies of the power supply current received by the electronic device, and allows passage of an output voltage of the power current output section, by reducing a frequency component higher than the cut-off frequency;
a parallel load section connected to an output end of the power current output section so as to be in parallel with the connection resistance, wherein the parallel load section a) consumes a partial power current being a part of the output power current from the power current output section when receiving a power current decrease signal instructing to decrease the power supply current, and b) stops receiving the partial power current from the power current output section when receiving a power current increase signal instructing to increase the power supply current;
an offset adder section that outputs a voltage obtained by adding an offset voltage to the output voltage of the low pass filter; and
a difference detection section that a) supplies the power current increase signal to the parallel load section while a potential of a device side end of the connection resistance positioned near the electronic device is smaller than a first reference voltage obtained by subtracting a first reference potential difference from the output voltage of the offset adder section, and b) supplies the power current decrease signal to the parallel load section when the potential of the device side end becomes larger than the first reference voltage, wherein
the offset adder section, according to change in the output voltage of the low pass filter, a) increases the offset voltage when the first reference potential difference is increased, and b) decreases the offset voltage when the first reference potential difference is decreased.

2. The power supply apparatus as set forth in claim 1, wherein
the difference detection section a) supplies the power current decrease signal to the parallel load section while the potential of the device side end is larger than a second reference voltage obtained by subtracting a second reference potential difference from the output voltage of the offset adder section, and b) supplies the power current increase signal to the parallel load section when the potential of the device side end becomes smaller than the second reference voltage, and
the offset adder section, according to change in the output voltage of the low pass filter, a) increases the offset voltage when the second reference potential difference is increased, and b) decreases the offset voltage when the second reference potential difference is decreased.

3. The power supply apparatus as set forth in claim 2, wherein
the difference detection section includes:
a reference voltage output section that outputs either the first reference voltage or the second reference voltage that is smaller than the first reference voltage, by dividing the output voltage of the offset adder section;
a first comparator that a) outputs the power current decrease signal to an output signal line when the potential of the device side end is larger than the reference voltage, and b) outputs the power current increase signal to the output signal line when the potential of the device side end is smaller than the reference voltage; and
a reference voltage setting section that, according to the output from the first comparator, causes the reference voltage output section to a) output the second reference voltage when the potential of the device side end becomes larger than the first reference voltage, and b) output the first reference voltage when the potential of the device side end becomes smaller than the second reference voltage, and
the parallel load section, based on the power current increase signal and the power current decrease signal supplied from the output signal line of the first comparator, a) consumes the partial power current received from the power current output section by running the partial power current to a path that is parallel to the connection resistance, during a period after the potential of the device side end has become larger than the first reference voltage till the potential of the device side end becomes smaller than the second reference voltage, and b) stops running the partial power current to the parallel path, during a period after the potential of the device side end has become smaller than the second reference voltage till the potential of the device side end becomes larger than the first reference voltage.

4. The power supply apparatus as set forth in claim 3, wherein
the offset adder section includes:
a first resistance connected to a third reference voltage higher than the output voltage of the low pass filter;
a second resistance connected between an output of the offset adder and an end of the first resistance to which the third reference voltage is not connected; and
a second comparator receiving input of the output voltage of the low pass filter and a voltage at a junction between the first resistance and the second resistance, the second comparator a) lowering the output voltage of the offset adder section when the voltage at the junction is larger than the output voltage of the low pass filter, and b) raising the output voltage of the offset adder section when the voltage at the junction is smaller than the output voltage of the low pass filter.

5. The power supply apparatus as set forth in claim 1, further comprising:
a delay section that delays more a timing of starting supplying the power current decrease signal to the parallel load section when a period since the difference detection section starts supplying the power current increase signal till the difference detection section starts supplying the power current decrease signal is longer.

6. A power supply apparatus that supplies a power supply current to an electronic device, the power supply apparatus comprising:
an output power current section that outputs an output power current that at least partially includes the power supply current;
a connection resistance that supplies, to the electronic device, the power supply current received from the power current output section, by electrically connecting the power current Output section and the electronic device;
a low pass filter that has a cut-off frequency lower than a variety of frequencies of the power supply current received by the electronic device, and allows passage of an output voltage of the power current output section, by reducing a frequency component higher than the cut-off frequency;
a parallel load section connected to an output end of the power current output section so as to be in parallel with the connection resistance, wherein the parallel load section a) consumes a partial power current being a part of the output power current from the power current output section when receiving a power current decrease signal instructing to decrease the power supply current, and b) stops receiving the partial power current from the power current output section when receiving a power current increase signal instructing to increase the power supply current;
a difference detection section that a) supplies the power current increase signal to the parallel load section when a potential of a device side end of the connection resistance positioned near the electronic device is smaller than a first reference voltage obtained by subtracting a predetermined value from the output voltage of the low pass filter, and b) supplies the power current decrease signal to the parallel load section when the potential of the device side end becomes larger than the first reference voltage; and
a delay section that delays more a timing of starting supplying the power current decrease signal to the parallel load section when a period since the difference detection section starts supplying the power current increase signal till the difference detection section starts supplying the power current decrease signal is longer.

7. The power supply apparatus as set forth in claim 6, wherein when the period since the difference detection section starts supplying the power current increase signal till the difference detection section starts supplying the power current decrease signal is longer, the delay section sets a time delay from when the difference detection section supplies the power current decrease signal and to when the power current decrease signal is supplied to the parallel load section longer than a time delay from when the difference detection section supplies the power current increase signal to when the power current increase signal is supplied to the parallel load section.

8. The power supply apparatus as set forth in claim 7, wherein
the delay section includes:
a base power current supply section that a) supplies a first base power current when the power current decrease signal is being supplied from the difference detection section, and b) supplies a second base power current that is larger than the first base power current when the power current increase signal is being supplied from the difference detection section,
a transistor that receives, at a base, input of the base power current supplied from the power current supply section, and saturates when receiving input of the second base power current; and
a power current control signal Output section that a) supplies the power current increase signal to the parallel load section, during an ON period of the transistor that is composed of a period in which the transistor is receiving input of the second base power current and a period in which the transistor is saturated, and b) supplies the power current decrease signal to the parallel load section in an OFF period in which the transistor is receiving input of the first power current and the transistor is not saturated.

9. The power supply apparatus as set forth in claim 8, wherein
the base power current supply section includes:
a first gate that a) outputs a signal of H level when supplied with the power current increase signal from the difference detection section, and b) outputs a signal of L level when supplied with the power current decrease signal from the difference detection section;
a third resistance provided between an output of the first gate and the base of the transistor; and
a diode provided in parallel with the third resistance, wherein the output of the first gate and the cathode are respectively connected to the base of the transistor and the anode.

10. A test apparatus that tests an electronic device, the test apparatus comprising:
a power current output section that outputs an output power current that at least partially includes a power supply current to be received by the electronic device;
a connection resistance that supplies, to the electronic device, the power supply current received from the power current output section, by electrically connecting the power current output section and the electronic device;
a low pass filter that has a cut-off frequency lower than a variety of frequencies of the power supply current received by the electronic device, and allows passage of an output voltage of the power current output section, by reducing a frequency component higher than the cut-off frequency;
a parallel load section connected to an output end of the power current output section so as to be in parallel with the connection resistance, wherein the parallel load section a) consumes a partial power current being a part of the output power current from the power current output section when receiving a power current decrease signal instructing to decrease the power supply current, and b) stops receiving the partial power current from the power current output section when receiving a power current increase signal instructing to increase the power supply current;
an offset adder section that outputs a voltage obtained by adding an offset voltage to the output voltage of the low pass filter; and
a difference detection section that a) supplies the power current increase signal to the parallel load section while a potential of a device side end of the connection resistance positioned near the electronic device is smaller than a first reference voltage obtained by subtracting a first reference potential difference from the output voltage of the offset adder section, and b) supplies the power current decrease signal to the parallel load section when the potential of the device side end becomes larger than the first reference voltage;
a pattern generating section that generates a test pattern to be inputted to the electronic device;
a signal input section that supplies the test pattern to the electronic device that receives the power supply current; and
a judgment section that judges whether the electronic device is defective or non-defective based on a signal that the electronic device outputs according to the test pattern, wherein
the offset adder section a) increases the offset voltage when the first reference potential difference is increased, and b) decreases the offset voltage when the first reference potential difference is decreased, according to change in the output voltage of the low pass filter.

11. A test apparatus that tests an electronic device, the test apparatus comprising:
a power current output section that outputs an output power current that at least partially includes the power supply current;
a connection resistance that supplies, to the electronic device, the power supply current received from the power current output section, by electrically connecting the power current output section and the electronic device;
a low pass filter that has a cut-off frequency lower than a variety of frequencies of the power supply current received by the electronic device, and allows passage of an output voltage of the power current output section, by reducing a frequency component higher than the cut-off frequency;
a parallel load section connected to an output end of the power current output section so as to be in parallel with the connection resistance, wherein the parallel load section a) consumes a partial power current being a part of the output power current from the power current Output section when receiving a power current decrease signal instructing to decrease the power supply current, and b) stops receiving the partial power current from the power current output section when receiving a power current increase signal instructing to increase the power supply current;
a difference detection section that a) supplies the power current increase signal to the parallel load section when a potential of a device side end of the connection resistance positioned near the electronic device is smaller than a first reference voltage obtained by subtracting a predetermined value from the output voltage of the low pass filter, and b) supplies the power current decrease signal to the parallel load section when the potential of the device side end becomes larger than the first reference voltage;
a delay section that delays more a timing of starting supplying the power current decrease signal to the parallel load section when a period since the difference detection section starts supplying the power current increase signal till the difference detection section starts supplying the power current decrease signal is longer;
a pattern generating section that generates a test pattern to be inputted to the electronic device;
a signal input section that supplies the test pattern to the electronic device that receives the power supply current; and
a judgment section that judges whether the electronic device is defective or non-defective based on a signal that the electronic device outputs according to the test pattern.

12. A power supply apparatus that supplies a power supply current to an electronic device, the power supply apparatus comprising:
a power current output section that outputs an output current including the power supply current supplied to the electronic device;
a load section that consumes a part of the output current; and
a difference detection section that reduces the power consumption of the load section in response to detecting that the power supply current consumed by the electronic device is increased.

13. The power supply apparatus as set forth in claim 12 further comprising:
a connection resistance connected between the power current output section and the electronic device that supplies to the electronic device, the power supply current received from the power current output section; and
an offset adder section that outputs a voltage obtained by adding an offset voltage to the output voltage of the power current output section,
the difference detection section includes a reference voltage output section that outputs a reference voltage based on the output voltage of the offset adder section and reduces the power consumption of the load section when the electric potential of the end of the electronic device side of the connection resistance close to the electronic device is less than the reference voltage, and
the offset adder section regulates the offset voltage so as to stabilize the potential difference between the output voltage of the power supply output section and the reference voltage when the magnitude of the output voltage of the offset adder section is changed.

14. The power supply apparatus as set forth in claim 12, wherein
the difference detection section increases the power consumption of the load section in response to detecting that the power supply current is reduced and reduces the power consumption in response to detecting that the power supply current is increased, and
the power supply apparatus further comprising a delay section that delays more a timing of increasing the power consumption when a period since the difference detection section reduces the power consumption till the difference detection section increases the power consumption is longer.

15. A test apparatus that tests an electronic device, comprising:
a power supply apparatus that supplies a power supply current to the electronic device; and
a test section that tests the electronic device,
the power supply apparatus including:
a power current output section that outputs an output current including the power supply current supplied to the electronic device;
a load section that consumes a part of the output current; and
a difference detection section that reduces the power consumption of the load section in response to detecting that the power supply current consumed by the electronic device is increased.

16. The test apparatus as set forth in claim 15, wherein
the power supply apparatus further including:
a connection resistance connected between the power current output section and the electronic device that supplies to the electronic device, the power supply current received from the power current output section; and
an offset adder section that outputs a voltage obtained by adding an offset voltage to the output voltage of the power current output section,
the difference detection section includes a reference voltage output section that outputs a reference voltage based on the output voltage of the offset adder section and reduces the power consumption of the load section when the electric potential of the end of the electronic device side of the connection resistance close to the electronic device is less than the reference voltage, and
the offset adder section corrects the offset voltage so as to stabilize the potential difference between the output voltage of the power supply Output section and the reference voltage when the magnitude of the output voltage of the offset adder section is changed.

17. The test apparatus as set forth in claim 15, wherein
the difference detection section increases the power consumption of the load section in response to detecting that the power supply current is reduced and reduces the power consumption in response to detecting that the power supply current is increased, and
the test apparatus further comprising a delay section that delays more a timing of increasing the power consumption when a period since the difference detection section reduces the power consumption till the difference detection section increases the power consumption is longer.
